(19) United States
(12) Patent Application Publication
(10) Pub. No.: US 2019/0215069 A1
(43) Pub. Date: Jul. 11, 2019

(54) MODE DIVISION MULTIPLEXING OPTICAL COMMUNICATION SYSTEM

(71) Applicants: STRAND S.R.L., Trieste (IT); UNIVERSITA' DEGLI STUDI DI PADOVA, Padova (IT)

(72) Inventors: Filippo ROMANATO, Padova (IT); Gianluca RUFFATO, Padova (IT)

(21) Appl. No.: 16/328,227

(22) PCT Filed: Aug. 24, 2017
(86) PCT No.: PCT/IB2017/055096

§ 371 Date: Feb. 25, 2019

(30) Foreign Application Priority Data
Aug. 25, 2016 (IT) 102016000087226

(51) Int. Cl. H04B 10/2581; G02B 6/28; H04J 14/04

(52) U.S. Cl. CPC H04B 10/2581; H04J 14/04; G02B 6/2848

(57) ABSTRACT

A mode division demultiplexing optical communication system comprises a multimode optical fiber, an optical device for demultiplexing modes with a different orbital angular momentum and a diffractive optical element. The optical fiber is configured to: receive at the input a first optical signal carried by a first guided mode having an orbital angular momentum, generate at the output the first optical signal carried by a first group of guided modes. The optical demultiplexing device is configured to: receive at the input a free space optical beam, generate at the output a first pair of free space optical beams. The diffractive optical element is configured to: receive at the input the first pair of free space optical beams and generate therefrom at the output a first pair of collimated optical beams, converge the first pair of collimated optical beams into a same first point in the space.

### BACKGROUND

### Technical Field

The present disclosure generally relates to the field of optical communications.

More specifically, the present disclosure concerns a mode division multiplexing optical communication system.

### Description of the Related Art

The capability of carrying data in optical fibers has increased over recent decades by means of the use of techniques such as Wavelength Division Multiplexing (WDM) and the polarization of light (Polarization Division Multiplexing, PDM); however, this is not sufficient to satisfy the significant increase in the amount of data requested.

Therefore, efforts have been made to further increase the capability of carrying data first through Spatial Division Multiplexing (SDM), based on which multicore optical fibers were developed, for the purpose of transmitting different optical signals for each core in the multicore fiber.

Subsequently, the Mode Division Multiplexing technique (MDM) was used, according to which it is possible to carry a plurality of spatial modes, which are orthogonal with each other, over the multimode optical fiber with a single core.

Mode division multiplexing can thus be considered a subset of the Spatial Division Multiplexing.

Among the spatial modes that can be carried over a multimode optical fiber, modes have been considered with orbital angular momentum, also known as OAM modes (OAM=Orbital Angular Momentum): in this case it is referred to as mode multiplexing of OAM-type (abbreviated as MDM-OAM).

The total angular momentum of a photon can be considered as the sum of an orbital angular momentum (OAM) and a spin angular momentum (SAM), wherein the latter assumes only two values s=±1.

The spin angular momentum (commonly referred to simply as “spin”) indicates the state of polarization of a beam of photons.

OAM modes can propagate both in free space and over an optical fiber: in the latter case, the term “guided OAM modes” will be used herein below to indicate their propagation over the optical fiber, in order to distinguish them from OAM modes propagating in the free space.

More specifically, guided OAM modes are characterized by the fact that they have a transverse spatial component of the electric field Eₜ (and magnetic field Hₜ) with uniform polarization state of a circular type (right or left) and by the fact that the surface of the wavefront of the transverse spatial component of the electric field Eₜ (and magnetic field Hₜ) has a helical trend, which is dextrorotatory (i.e., the direction of the screw is clockwise) or levorotatory (i.e., the direction of the screw is anticlockwise): for this reason the guided OAM modes are also commonly referred to as “circular optical vortices” or “helical modes”.

The pitch of the screw (of the surface of the wavefront of the transverse spatial component of the electric field Eₜ and magnetic field Hₜ) is the minimum distance between two distinct points of the screw having the same coordinates in the plane (x, y) perpendicular to the propagation direction z (i.e., the pitch of the screw is equal to the wavelength λ).

Guided OAM modes are identified by the following parameters:

a radial index “p” having integer values greater than zero (p=1, 2, 3, . . . ), which defines the trend of the amplitude of the transverse spatial component of the electric field Eₜ (and magnetic field Hₜ) as the radial distance changes from the propagation axis z of the guided OAM modes, which coincides with the axis of the optical fiber (thus the amplitude of the electric field Eₜ has (p−1) radial nodes);

an angular index “l” (commonly also indicated as the “topological charge”) having integer values (l=0, ±1, ±2, ±3, . . . ), wherein for l>0 the wavefront is constituted by l interlaced screws;

the direction of the screw, which can be dextrorotatory or levorotatory, as a function of the positive or negative value of the angular index l;

the state of circular polarization, i.e. dextrorotatory or levorotatory.

The luminous intensity of the guided OAM modes (i.e. of the circular optical vortices) on a plane perpendicular to the propagation direction (commonly known as a “luminous spot”) has a substantially circular shape and it is distributed in p concentric rings (wherein p is the radial index), for l greater than or equal to 1. In particular, the luminous intensity is null on the propagation axis of the considered OAM mode, at a locus of singular points wherein the phase is not defined.

Guided OAM modes are a plurality of spatial modes that are orthogonal each other, i.e. they are carried independently in case wherein they are propagated over an optical fiber which maintains the circular symmetry and which is not subject to external perturbation that deforms the optical fiber: in this case the exchange of energy between different modes carried over the multimode optical fiber is theoretically null; in a case of vacuum propagation, the condition of orthogonality of the OAM modes is always satisfied.

Guided OAM modes are a linear combination of degenerate HE or EH vectorial modes propagating over a multimode optical fiber.

The set of degenerate or quasi-degenerate HE/EH vectorial modes (that is, modes having values of the propagation constant that differ slightly) constitutes a group of modes.

Each group of modes contains a number of degenerate or quasi-degenerate guided OAM modes.

Channel crosstalk between different guided modes belonging to a group of quasi-degenerate guided modes is a known problem.

In particular, at the input of a multimode optical fiber the optical signal is injected into a guided mode of a given group of modes and during propagation of the optical signal along the optical fiber, it is excited (due to the channel crosstalk) not only the input guided mode, but also the other guided modes belonging to the same group of modes: therefore coupling between guided modes occurs, which causes the undesired transfer of energy of the optical signal carried by the input guided mode to the optical signal carried by the other guided modes belonging to the same group of modes, resulting in deterioration of the signal/noise ratio of the optical signal received at the output of the optical fiber.

A known technique used to solve the problem of the channel crosstalk is commonly referred to as MIMO (Multiple Input, Multiple Output), which provides to perform a digital processing of the signal received at electronic level, that is after having carried out at the receiver the conversion of from optical signal to electricalsignal.

The Applicant has observed that the MIMO technique has the following disadvantages:

it requires digital processing of the received signal at electronic level, which has a high computational cost;

it requires the presence of electronic components to perform said digital processing of the signal, thus increasing energy consumption;

the bit error rate of the received signal is not always sufficiently low.

The Applicant has also observed that the connection between an optical fiber and an optical signal transmission system and between an optical fiber and an optical signal receiving system requires complex and expensive systems for realization of the refractive lenses and the alignment thereof with the fiber.

This problem is heightened in the case of a complex system of standards needed for realizing an optical transceiver apparatus based on mode division.

Therefore, an optical transceiver system based on OAM mode division requires a cheap system for realization and alignment of the lenses.

### BRIEF SUMMARY

The present disclosure concerns a mode division demultiplexing optical communication system as defined in the enclosed claim 1 and by its preferred embodiments disclosed in the dependent claims 2 to 14.

The optical communication system uses purely optical demultiplexing based on OAM modes.

The Applicant has noted that the optical communication system according to the present disclosure is capable of directly recovering at the optical level (i.e., by optical integration) most of the optical signal carried by a guided OAM mode over a multimode optical fiber available on the market (e.g. of a step-index or graded-index type), in which said optical signal has been dispersed within a group of quasi-degenerate guided modes due to channel crosstalk: in this way the use of MIMO techniques can be avoided, thus considerably reducing the computational and energy costs of processing at the electronic level the received signal and the bit error rate of the received signal is also reduced.

The optical system can be integrated with other multiplexing methods, in particular the wavelength division multiplexing (WDM) and the polarization division multiplexing.

One embodiment of the present disclosure relates to a mode division multiplexing optical communication system as defined in the enclosed claim 15.

The optical communication system uses purely optical multiplexing based on OAM modes.

The lenses constituting the optical communication systems can be realized according to micro-fabrication techniques as specified in claim 16.

Said techniques allow the alignment and production thereof in a precise and cheap manner.

One embodiment of the present disclosure relates to an optical transceiver system as defined in the enclosed claim 17.

The optical transceiver system allows to perform multiplexing, optical fiber insertion, transmission over an optical fiber and demultiplexing of optical signals at the transmission frequencies of the telecommunications networks.

The optical transceiver system uses purely optical multiplexing and demultiplexing based on OAM modes.

### BRIEF DESCRIPTION OF THE SEVERAL VIEWS OF THE DRAWINGS

Further characteristics and advantages of the disclosure will emerge from the following description of a preferred embodiment and variants thereof, said description being provided by way of example with reference to the enclosed drawings, wherein:

FIGS. 1A-1B schematically show a mode division multiplexing optical communication system for performing demultiplexing of guided modes with a different orbital angular momentum according to a first embodiment of the disclosure;

FIG. 2 schematically shows a mode and polarizationdivision multiplexing optical communication system for performing demultiplexing of guided modes with a different orbital angular momentum and a different state of polarization according to a second embodiment of the disclosure;

FIGS. 3A-3B schematically show a realization of the optical elements of FIG. 2 by means of lithographic techniques on silicon or silicon nitride membranes;

FIG. 3C schematically shows an embodiment of a sequence of optical elements that are aligned and lithographed on silicon or silicon nitride membranes;

FIGS. 4A-4B show in greater detail two possible embodiments of an optical device within the optical communication system of FIGS. 1A-1B and 2;

FIG. 5A shows in greater detail a top view of an optical element inside the optical devices of FIGS. 4A-4B;

FIG. 5B shows in greater detail a top view of the optical element inside the optical devices of FIGS. 4A-4B, also serving to perform wavelength division demultiplexing;

FIG. 5C shows in greater detail a top view of the optical element of FIG. 5A implemented on silicon or silicon nitride membranes;

FIG. 6 schematically shows a mode division multiplexing optical communication system for performing multiplexing of guided modes with a different orbital angular momentum according to the disclosure;

FIG. 7 schematically shows an optical transceiver system for mode multiplexing and demultiplexing with different orbital angular momentum according to the disclosure.

### DETAILED DESCRIPTION

It should be observed that in the following description, identical or similar blocks, components or modules are indicated in the figures with the same numerical references, even if they are shown in different embodiments of the disclosure.

As indicated above, the guided OAM modes are a linear combination of the quasi-degenerate HE/EH vectorial modes (that is, with values of the propagation constant differing slightly) propagating in a multimode optical fiber.

The set of quasi-degenerate HE/EH vectorial modes that compose a given guided OAM mode constitutes a group of modes.

Herein below, the notation OAM±_{l,p} will be used to indicate a guided OAM mode having an angular index ±l and a radial index p.

More specifically, the following notations will be used herein below:

OAM_{-l,p}_{^{left}}: it indicates a guided OAM mode having a negative angular index l (and thus a levorotatory helical trend) and a levorotatory circular state of polarization;

OAM_{-l,p}_{^{right}}: it indicates a guided OAM mode having a negative angular index l (and thus a levorotatory helical trend) and a dextrorotatory circular state of polarization;

OAM_{+l,p}_{^{left}}: it indicates a guided OAM mode having a positive angular index l (and thus a dextrorotatory helical trend) and a levorotatory circular state of polarization;

OAM_{+l,p}_{^{right}}: it indicates a guided OAM mode having a positive angular index l (and thus a dextrorotatory helical trend) and a dextrorotatory circular state of polarization.

If one considers weakly guiding approximation in which the difference between the refraction index for the core of the optical fiber and the refraction index for the cladding of the optical fiber is disregarded, the guided OAM modes belonging to the same group of modes prove to be degenerate (that is, they have the same value of the propagation constant) and the linear combination of two or more degenerate guided OAM modes generates the linearly polarized modes LP_{m,n}.

In particular, the Applicant has found out that if one considers the propagation of guided OAM modes in a multimode optical fiber of the step-index type, the following groups of guided modes can for example be defined:

group 0: the guided mode LP_{0,1} is the linear combination of two guided OAM modes which are OAM_{0,1}_{^{1eft}} and OAM_{0,1}_{^{right}}, having a null angular index and opposite states of polarization (or, alternatively, the guided mode LP_{0,1} is the combination of the two vectorial modes, which are HE₁₁_{^{odd}} and HE₁₁_{^{even}});

group 1: the guided mode LP_{1,1} is the linear combination of two guided OAM modes which are OAM_{-1,1}_{^{left}} and OAM_{+1,1}_{^{right}}, and two vectorial modes which are TE₀₁ and TM₀₁ (or alternatively, the guided mode LP_{1,1} is the linear combination of four vectorial modes, which are TE₀₁, HE₂₁_{^{even}}, HE₂₁_{^{odd}} and TM₀₁);

group 2: the guided mode LP_{2,1} is the linear combination of four guided OAM modes which are OAM_{+2,1}_{^{left}}, OAM_{-2,1}_{^{right}}, OAM_{-2,1}_{^{left}}, OAM_{+2,1}_{^{right}} (or, alternatively, the guided mode LP_{2,1} is the linear combination of four vectorial modes, which are EH₁₁_{^{even}}, EH₁₁_{^{odd}}, HE₃₁_{^{even}}, HE₃₁_{^{odd}});

group 3: the guided mode LP_{3,1} is the linear combination of four guided OAM modes which are OAM_{+3,1}_{^{left}}, OAM_{-3,1}_{^{right}}, OAM_{-3,1}_{^{left}}, OAM_{+3,1}_{^{right}} (or, alternatively, the guided mode LP_{3,1} is the linear combination of four vectorial modes, which are EH₂₁_{^{even}}, EH₂₁_{^{odd}}, HE₄₁_{^{even}}, HE₄₁_{^{odd}});

group 4: the guided mode LP_{1,2} is the linear combination of two guided OAM modes which are OAM_{-1,2}_{^{left}} and OAM_{+1,2}_{^{right}}, and two vectorial modes, which are TE₀₂ and TM₀₂ (or, alternatively, the guided mode LP_{1,2} is the linear combination of four vectorial modes, which are TE₀₂, HE₂₂_{^{even}}, HE₂₂_{^{odd}}, TM₀₂);

group 5: the guided mode LP_{4,1} is the linear combination of four guided OAM modes which are OAM_{+4,1}_{^{left}}, OAM_{-4,1}_{^{right}}, OAM_{-4,1}_{^{left}}, OAM_{+4,1}_{^{right}}, or, alternatively, the guided mode LP_{4,1} is the linear combination of four vectorial modes, which are EH₃₁_{^{even}}, EH₃₁_{^{odd}}, HE₅₁_{^{even}} and HE₅₁_{^{odd}};

group 6: the guided mode LP_{5,1} is the linear combination of four guided OAM modes which are OAM_{+5,1}_{^{left}}, OAM_{-5,1}_{^{right}}, OAM_{-5,1}_{^{left}}, OAM_{+5,1}_{^{right}}, or, alternatively, the guided mode LP_{5,1} is the linear combination of four vectorial modes, which are EH₄₁_{^{even}}, EH₄₁_{^{odd}}, HE₆₁_{^{even}} and HE₆₁_{^{odd}};

group 7: the guided mode LP_{1,3} is the linear combination of two guided OAM modes which are OAM_{-1,3}_{^{left}} and OAM_{+1,3}_{^{right}}, and two vectorial modes, which are TE₀₃ and TM₀₃ (or, alternatively, the guided mode LP_{1,3} is the linear combination of four vectorial modes, which are TE₀₃, HE₂₃_{^{even}}, HE₂₃_{^{odd}}, TM₀₃);

group 8: the guided mode LP_{6,1} is the linear combination of four guided OAM modes which are OAM_{+6,1}_{^{left}}, OAM_{-6,1}_{^{right}}, OAM_{-6,1}_{^{left}}, OAM_{6,1}_{^{right}}, or, alternatively, the guided mode LP_{6,1} is the linear combination of four vectorial modes, which are EH₅₁_{^{even}}, EH₅₁_{^{odd}}, HE₇₁_{^{even}} and HE₇₁_{^{odd}}.

Note that group 1 can also be considered alternatively as composed of only degenerate or quasi-degenerate OAM modes, because the guided modes TE₀₁ and TM₀₁ can also be considered a combination of guided OAM modes; in particular, the guided modes TE₀₁,TM₀₁ are the linear combination of guided modes of the OAM_{+1,1}_{^{left}} and OAM_{-1,1}_{^{right}} type.

The considerations concerning group 1 are applicable in a similar manner also to groups 4 and 7, which can be considered composed of only degenerate or quasi-degenerate OAM modes.

Table 1 below summarizes the association between groups—guided LP modes and the guided vectorial modes—and guided OAM modes for a multimode fiber of the step-index type, in which said association is represented in increasing order of the value of the angular index l of the guided OAM modes:

TABLE 1

| Number of | Guided | Guided | Guided | |
|---|---|---|---|---|
| guided modes | LP | vectorial | OAM | Angular |
| in the group | modes | modes | modes | index |
| 2 | LP_{0,1} | HE₁₁^{odd}, | OAM_{0,1}^{left}, | 0 |
| | | HE₁₁^{even} | OAM_{0,1}^{right} | |
| 4 | LP_{1,1} | TE₀₁, | OAM_{-1,1}^{left}, | 0 |
| | | HE₂₁^{even}, | OAM_{+1,1}^{right} | ±1 |
| | | HE₂₁^{odd} | | 0 |
| | | TM₀₁ | | |
| 4 | LP_{2,1} | EH₁₁^{even}, | OAM_{+2,1}^{left}, | ±2 |
| | | EH₁₁^{odd}, | OAM_{-2,1}^{right}, | |
| | | HE₃₁^{even}, | OAM_{-2,1}^{left}, | |
| | | HE₃₁^{odd}, | OAM_{+2,1}^{right} | |
| 4 | LP_{3,1} | EH₂₁^{even}, | OAM_{+3,1}^{left}, | ±3 |
| | | EH₂₁^{odd}, | OAM_{-3,1}^{right}, | |
| | | EH₄₁^{even}, | OAM_{-3,1}^{left}, | |
| | | HE₄₁^{odd}, | OAM_{+3,1}^{right} | |
| 4 | LP_{1,2} | TE₀₂, | OAM_{-1,2}^{left}, | 0 |
| | | HE₂₂^{even}, | OAM_{+1,2}^{right} | ±1 |
| | | HE₂₂^{odd}, | | 0 |
| | | TM₀₂ | | |
| 4 | LP_{4,1} | EH₃₁^{even}, | OAM_{+4,1}^{left}, | ±4 |
| | | EH₃₁^{odd}, | OAM_{-4,1}^{right}, | |
| | | HE₅₁^{even}, | OAM_{-4,1}^{left}, | |
| | | HE₅₁^{odd}, | OAM_{+4,1}^{right} | |
| 4 | LP_{5,1} | EH₄₁^{even}, | OAM_{+5,1}^{left}, | ±5 |
| | | EH₄₁^{odd}, | OAM_{-5,1}^{right}, | |
| | | HE₆₁^{even}, | OAM_{-5,1}^{left}, | |
| | | HE₆₁^{odd}, | OAM_{+5,1}^{right} | |
| 4 | LP_{1,3} | TE₀₃ | OAM_{-1,3}^{left}, | 0 |
| | | HE₂₃^{even}, | OAM_{+1,3}^{right} | ±1 |
| | | HE₂₃^{odd}, | | 0 |
| | | TM₀₃ | | |
| 4 | LP_{6,1} | EH₅₁^{even}, | OAM_{+6,1}^{left}, | ±6 |
| | | EH₅₁^{odd}, | OAM_{-6,1}^{right}, | |
| | | HE₇₁^{even}, | OAM_{-6,1}^{left}, | |
| | | HE₇₁^{odd}, | OAM_{+6,1}^{right} | |

Therefore in case of propagation of the optical signal over a multimode fiber of the step-index type, a guided linear mode LP_{m,n} defines a respective group of guided modes, wherein each group of modes comprises a plurality of degenerate or quasi-degenerate guided OAM modes which undergo mode coupling due to the channel crosstalk occurring during propagation of the optical signal from the input to the output of the step-index multimode optical fiber; differently, guided OAM modes belonging to groups of different modes do not undergo mode coupling during propagation of the optical signal from the input to the output of the step-index multimode optical fiber.

Crosstalk between guided modes within a single group is responsible for the distribution of the intensity of the electromagnetic field of the optical signal initially injected into the guided modes belonging to the group considered; in a complex manner that cannot be determined in advance, the distribution process depends on the inevitable imperfections with which optical fibers are made and on the degree of curvature or deformation thereof during use.

However, the groups of guided modes are separated from each other; in fact, a first optical signal transmitted by a group of modes interacts very weakly with a second optical signal transmitted by a second group of modes.

Therefore, the crosstalk is negligible between the groups of guided modes and this allows to use them as distinct channels for independent transmission of single optical signals.

The optical system of the disclosure is capable of distributing different optical signals provided with a different angular momentum, one for each group of guided modes, and of independently transmitting these optical signals by means of these independent groups of guided modes.

The optical signal injected at the input of the optical fibers into one of the modes of a group can disperse its intensity over the modes of that group, but not over those of other groups (or in any case, the crosstalk between different groups is very limited).

The disclosure allows, after transmission of the optical signals, to recover the intensity of an optical signal distributed over the modes of the group that transmit it and, at the same time, it allows to divide optical signals transmitted by different groups.

In particular, in the case of the step-index multimode optical fiber, it can be observed that if it is injected, at the input of the optical fiber, the optical signal into a guided OAM mode of the OAM_{-1,1}_{^{left}} type belonging to the first group of modes defined by the linear mode LP_{1,1}, at the output of the optical fiber it is received (due to crosstalk between the guided OAM modes belonging to the same group) the same signal (minus attenuation along the optical fiber) transmitted in the guided OAM mode of the OAM_{-1,1}_{^{left}} type (i.e., with an angular index of l=−1), but partly transmitted also in the guided OAM mode of the OAM_{+1,1}_{^{right}} type (i.e., with an angular index of l=+1 having the same value and opposite sign) belonging to the first group of modes defined by the same linear mode LP_{1,1} and partly transmitted also in the vectorial modes TE₀₁ and TM₀₁ which also belong to the first group of modes.

Alternatively, if it is injected, at the input of the optical fiber, the optical signal into a guided OAM mode of the OAM_{+1,1}_{^{right}} type of the first group of guided modes, at the output of the optical fiber it is received (due to crosstalk between the guided OAM modes belonging to the same group) the same signal (minus attenuation along the optical fiber) transmitted in the guided OAM mode of the OAM_{+1,1}_{^{right}} type (i.e., with an angular index of l=+1), but partly transmitted also in the guided OAM mode of the OAM_{-1,1}_{^{left}} type (i.e., with an angular index of l=−1 having the same value and opposite sign) of the same first group of guided modes and partly transmitted also in the vectorial modes TE₀₁ and TM₀₁ which also belong to the first group of modes.

Similar considerations can be made for the guided OAM modes of the other groups of modes defined by the linear modes LP_{m,n} in Table 1.

For example, if it is injected, at the input of the optical fiber, the optical signal into the guided OAM mode of the OAM_{+2,1}_{^{left}} type belonging to the second group of modes defined by the linear mode LP_{2,1}, at the output of the optical fiber it is received (due to crosstalk between the guided OAM modes belonging to the same group) the same signal (minus attenuation along the optical fiber) transmitted partly in the guided OAM mode of the OAM_{+2,1}_{^{left}} type (i.e., with an angular index of l=+2), but partly transmitted also in the guided OAM modes of the OAM_{+2,1}_{^{right}} type (i.e., with an angular index of l=+2 having the same value and same sign) and of the OAM_{-2,1}_{^{right}} and OAM_{-2,1}_{^{left}} type (both with an angular index of l=−2 and having the same value but opposite sign), which also belong to the second group of modes defined by the same linear mode LP_{2,1}.

Differently, if it is injected, at the input of the multimode optical fiber, both a first optical signal into the guided mode OAM_{-1,1}_{^{left}} of the first modes group LP_{1,1} and a second optical signal into the guided mode OAM_{+2,1}_{^{left}} of the second modes group LP_{2,1}, at the output of the optical fiber it is received the first optical signal in the first group of modes LP_{1,1} separated from the second optical signal in the second group of modes LP_{2,1}.

Note that the group of modes indicated in Table 1 for a step-index optical fiber are identified (for l>1 and p=1) by only one different value for the angular index l which can be positive or negative, that is:

group 2 of LP_{2,1} modes is composed of guided OAM modes having an angular index of l=±2;

group 3 of LP_{3,1} modes is composed of guided OAM modes having an angular index of l=±3;

group 5 of LP_{4,1} modes is composed of guided OAM modes having an angular index of l=±4;

group 6 of LP_{5,1} modes is composed of guided OAM modes having an angular index of l=±5;

group 8 of LP_{6,1} modes is composed of guided OAM modes having an angular index l=±6;

and so forth.

Note also that the groups of modes indicated in Table 1 do not represent a complete list, i.e. they are only examples and other groups of modes can be identified.

In particular, note the sequence of groups of the LP_{l,1} type in step-index fibers, wherein l is the angular momentum number identifying the group.

The group is identified by modes of the following types: OAM_{+l,1}_{^{left}}, OAM_{-l,1}_{^{right}}, OAM_{-l,1}_{^{left}} and OAM_{+l,1}_{^{right}}.

The preceding considerations concerning the guided mode groups in a multimode optical fiber of the step-index type are applicable in a similar manner to a multimode optical fiber of the “graded index” type, thereby obtaining groups of modes according to Table 2 below:

TABLE 2

| Number of | Guided | Guided | Guided | |
|---|---|---|---|---|
| guided modes | LP | vectorial | OAM | Angular |
| in the group | modes | modes | modes | index |
| 2 | LP_{0,1} | HE₁₁^{even}, HE₁₁^{odd} | OAM_{+0,1}, | 0 |
| | | | OAM_{-0,1}^{right} | |
| 4 | LP_{1,1} | TE₀₁, | OAM_{-1,1}^{left}, | 0 |
| | | HE₂₁^{even}, | OAM_{+1,1}^{right} | ±1 |
| | | HE₂₁^{odd}, | | 0 |
| | | TM₀₁ | | |
| 6 | LP_{2,1} | EH₁₁^{even}, EH₁₁^{odd}, | OAM_{+2,1}^{left}, | ±2 |
| | | HE₃₁^{even}, HE₃₁^{odd} | OAM_{-2,1}^{right,} | |
| | | | OAM_{-2,1}^{left}, | |
| | | | OAM_{+2,1}^{right}, | |
| | LP_{0,2} | HE₁₂^{even}, HE₁₂^{odd} | OAM_{+0,2}^{right}, | 0 |
| | | | OAM_{-0,2}^{left}, | |
| 8 | LP_{3,1} | EH₂₁^{even}, EH₂₁^{odd}, | OAM_{+3,1}^{left}, | ±3 |
| | | HE₄₁^{even}, HE₄₁^{odd} | OAM_{-3,1}^{right}, | |
| | | | OAM_{-3,1}^{left}, | |
| | | | OAM_{+3,1}^{right} | |
| | LP_{1,2} | TE₀₂, | OAM_{-1,2}^{left}, | 0 |
| | | HE₂₂^{even}, | OAM_{+1,2}^{right} | ±1 |
| | | HE₂₂^{odd}_{,} | | 0 |
| | | TM₀₂ | | |
| 10 | LP_{4,1} | EH₃₁^{even}, EH₃₁^{odd}, | OAM_{+4,1}^{left}, | ±4 |
| | | HE₅₁^{even}, HE₅₁^{odd} | OAM_{-4,1}^{right}, | |
| | | | OAM_{-4,1}^{left}, | |
| | | | OAM_{+4,1}^{right} | |
| | LP_{2,2} | EH₁₂^{even}, EH₁₂^{odd}, | OAM_{+2,2}^{left}, | ±2 |
| | | HE₃₂^{even}, HE₃₂^{odd} | OAM_{-2,2}^{right}, | |
| | | | OAM_{-2,2}^{left}, | |
| | | | OAM_{+2,2}^{right} | |
| | LP_{0,3} | HE₁₃^{even}, HE₁₃^{odd} | OAM_{+0,3}^{right}, | 0 |
| | | | OAM_{-0,3}^{left} | |
| 12 | LP_{5,1} | EH₄₁^{even}, EH₄₁^{odd}, | OAM_{+5,1}^{left}, | ±5 |
| | | HE₆₁^{even}, HE3₆₁^{odd} | OAM_{-5,1}^{right}, | |
| | | | OAM_{-5,1}^{left}, | |
| | | | OAM_{+5,1}^{right} | |
| | LP_{3,2} | EH₂₂^{even}, EH₂₂^{odd}, | OAM_{+3,2}^{left}, | ±3 |
| | | HE₄₂^{even}, HE₄₂^{odd} | OAM_{-3,2}^{right}, | |
| | | | OAM_{-3,2}^{left}, | |
| | | | OAM_{+3,2}^{right} | |
| | LP_{1,3} | TE₀₃ | OAM_{-1,3}^{left}, | 0 |
| | | HE₂₃^{even}, | OAM_{+1,3}^{right} | ±1 |
| | | HE₂₃^{odd}, | | 0 |
| | | TM₀₃ | | |
| 14 | LP_{6,1} | EH₅₁^{even}, EH₅₁^{odd}, | OAM_{+6,1}^{left}, | ±6 |
| | | HE₇₁^{even}, HE₇₁^{odd} | OAM_{-6,1}^{right}, | |
| | | | OAM_{-6,1}^{left}, | |
| | | | OAM_{+6,1}^{right} | |
| | LP_{4,2} | EH₃₂^{even}, EH₃₂^{odd}, | OAM_{+4,2}^{left}, | ±4 |
| | | HE₅₂^{even}, HE₅₂^{odd} | OAM_{-4,2}^{right}, | |
| | | | OAM_{-4,2}^{left}, | |
| | | | OAM_{+4,2}^{right} | |
| | LP_{2,3} | EH₁₃^{even}, EH₁₃^{odd}, | OAM_{+2,3}^{left}, | ±2 |
| | | HE₃₃^{even}, HE₃₃^{odd} | OAM_{-2,3}^{right}, | |
| | | OAM₋₂₃^{left}, | OAM_{+2,3}^{right} | |
| | LP_{0,4} | HE₁₄^{even}, HE₁₄^{odd} | OAM_{+0,4}^{right}, | 0 |
| | | | OAM_{-0,4}^{left} | |

Therefore in case of propagation of the optical signal over a multimode fiber of the graded-index type, a group of modes can be defined by only one group of guided linear modes LP_{m,n}, or it can be defined by two or more groups of guided linear modes LP_{m,n}.

In particular:

group 1 is defined by one group of guided linear modes LP_{0,1} and it is composed of 2 guided vectorial modes;

group 2 is defined by one group of guided linear modes LP_{1,1} and it is composed of 4 guided vectorial modes;

group 3 is defined by two groups of guided linear modes LP_{2,1}, LP_{0,2} and it is composed of 6 guided vectorial modes;

group 4 is defined by two groups of guided linear modes LP_{3,1},LP_{1,2} and it is composed of 8 guided vectorial modes;

group 5 is defined by three groups of guided linear modes LP_{4,1}, LP_{2,2}, LP_{0,3} and it is composed of 10 guided vectorial modes;

group 6 is defined by three groups of guided linear modes LP_{5,1}, LP_{3,2}, LP_{1,3} and it is composed of 12 guided vectorial modes;

group 7 is defined by four groups of guided linear modes LP_{6,1}, LP_{4,2}, LP_{2,3}, LP_{0,4}, and it is composed of 14 guided vectorial modes.

Note that (differently from Table 1) a group of modes in Table 2 for a graded-index fiber can be identified by only one positive/negative value of the angular index l, (group 1 having l=0, group 2 having l=±1), or a group of modes for the graded-index fiber can be identified by two or more positive/negative values of the angular index l (group 3 having l=±2, 0; group 4 having l±3, ±1; group 5 having l=±4, ±2, 0; group 6 having l=±5, ±3,±1, group 7 having l=±6, ±4, ±2, 0).

Note that the groups of modes indicated in Table 2 do not represent a complete list, i.e. they are only one example and other groups of modes can be identified.

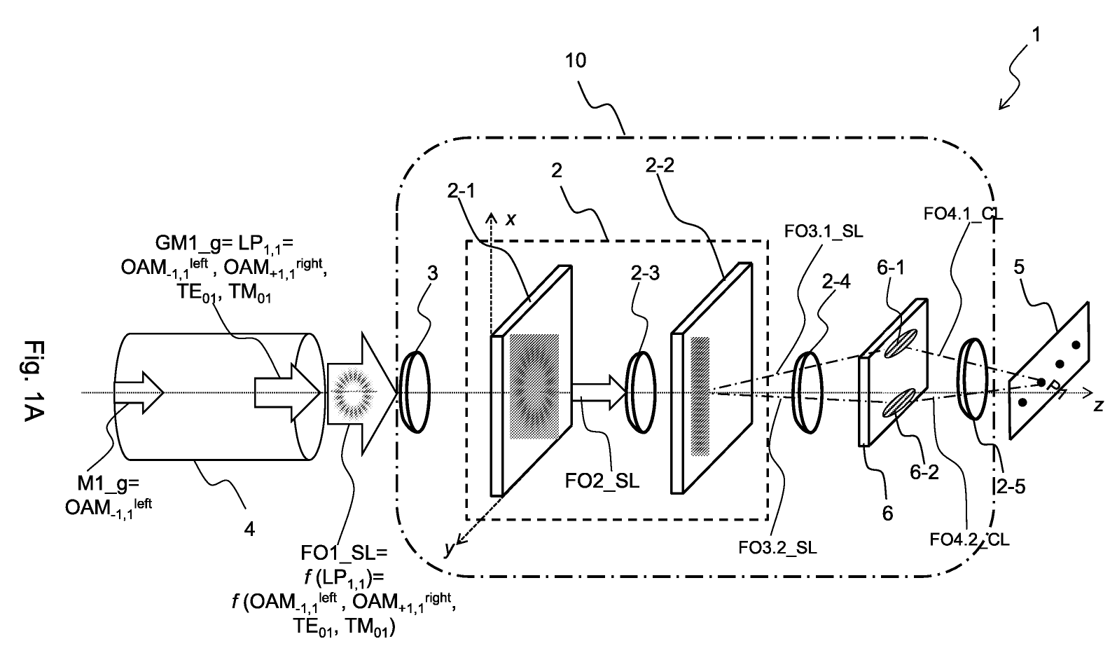

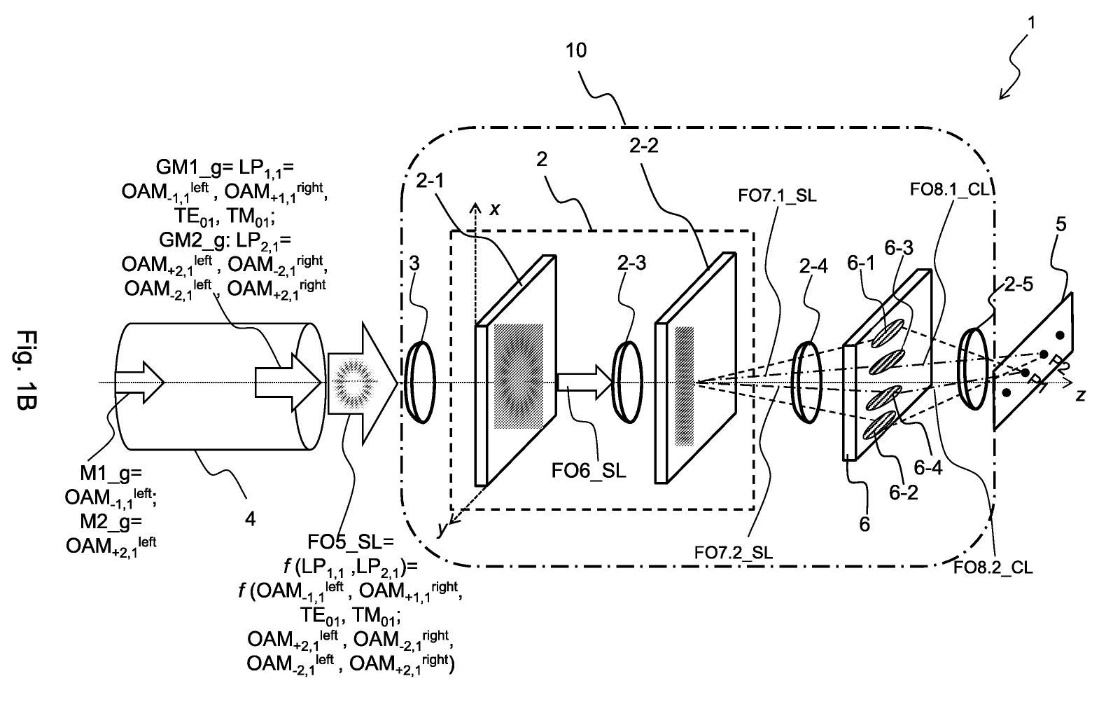

With reference to FIGS. 1A-1B, a mode division demultiplexing optical communication system 1 is schematically shown according to a first embodiment of the disclosure, which allows to transmit over the fiber and to receive optical signals by means of groups of guided modes.

More specifically, the optical communication system 1 has the function of performing demultiplexing of guided OAM modes with a different orbital angular momentum; subsequently, the configuration of the system for performing the multiplexing of guided OAM modes with a different orbital angular momentum will also be shown.

For the purposes of explaining the disclosure, for the sake of simplicity, the case shown in FIG. 1A considers a first optical signal that is injected into the multimode optical fiber 4 and that is carried over a guided OAM mode belonging to only one group of modes; more specifically, in FIG. 1A the optical signal is injected into the OAM_{-1,1}_{^{left}} mode belonging to group 1 of Table 1.

Moreover, FIG. 1B shows that a second optical signal is further injected into the multimode optical fiber 4 in a guided OAM mode of the OAM_{+2,1}_{^{left}} type belonging to group 2 of Table 1, that is in the embodiment shown in FIG. 1B both the first optical signal in the OAM_{-1,1}_{^{left}} mode and a second optical signal in the OAM_{+2,1}_{^{left}} mode belonging to group 2 in Table 1 are injected into the multimode optical fiber 4: in this way OAM mode multiplexing is implemented with the two guided OAM modes of the OAM_{-1,1}_{^{left}} and OAM_{+2,1}_{^{left}} type belonging to distinct groups of modes.

Therefore in FIG. 1A the optical fiber 4 is configured to carry the information at the input thereof over a first channel associated with the guided mode OAM_{-1,1}_{^{left}}, whereas in FIG. 1B the optical fiber 4 is configured to further carry the information at the input thereof over a second channel associated with the guided mode OAM_{+2,1}_{^{left}}.

In more general terms, the disclosure is applicable to the case in which two or more optical signals are injected together into the multimode optical fiber 4, said two or more optical signals being transmitted over two or more respective guided OAM modes belonging to different groups of modes; in this case the optical fiber 4 is configured to carry the information at the input thereof over two or more channels associated with two or more respective guided OAM modes belonging to different groups of modes, thereby implementing OAM-type mode division multiplexing.

For example, six optical signals are injected together into the multimode optical fiber 4 over six respective guided modes: OAM_{-1,1}_{^{left}}, OAM_{+2,1}_{^{left}}, OAM_{+3,1}_{^{left}}, OAM_{+4,1}_{^{left}}, OAM_{+5,1}_{^{left}} and OAM_{+6,1}_{^{left}}: in this case the optical fiber 4 is configured to carry the information at the input thereof over six channels associated with the six guided modes OAM_{-1,1}_{^{left}}, OAM_{+2,1}_{^{left}}, OAM_{+3,1}_{^{left}}, OAM_{+4,1}_{^{left}}, OAM_{+5,1}_{^{left}} and OAM_{+6,1}_{^{left}}, respectively, belonging to different groups of guided modes, as indicated in Tables 1 and 2.

With reference to FIG. 1A, the mode division demultiplexing optical communication system 1 comprises a multimode optical fiber 4 and an optical device 10 for demultiplexing guided OAM modes.

The optical device 10 has both the function of performing the demultiplexing of guided OAM modes with different orbital angular momentum (that is, with different values l₁, l₂, l₃ of the angular index l) and the function of recovering for each group of modes most of the energy of the optical signal that has been distributed over the different guided OAM modes of the respective group to which the considered guided OAM mode belongs.

The multimode optical fiber 4 is capable of carrying two or more guided modes, in particular guided OAM modes, that is guided modes with different orbital angular momentum.

The optical fiber 4 is available on the market, for example of the step-index or graded-index type, and it is configured to cause channel crosstalk between guided modes belonging to the same group of modes.

In particular, the optical fiber 4 is configured to transmit, from the input towards the output, a first input optical signal carried by a guided OAM mode M1_g having an angular index of l=1, a radial index of p=1 and a levorotatory circular state of polarization: this guided OAM mode shall be indicated below as OAM_{-1,1}_{^{left}} and it belongs to modes group 1 defined by the guided linear mode LP_{1,1}.

During propagation of the guided OAM mode OAM_{-1,1}_{^{left}} from the input to the output of the optical fiber 4, the latter is configured to also excite the further guided OAM mode OAM_{+1,1}_{^{right}} having an angular index l=+1, radial index p=1 and dextrorotatory circular state of polarization, because the latter also belongs to modes group 1 defined by the guided linear mode LP_{1,1}: in this manner a part of the energy (for example, less than 60%) of the input optical signal carried by the guided OAM mode OAM_{-1,1}_{^{left}} is transferred over the guided OAM mode OAM_{+1,1}_{^{right}}.

Moreover, during propagation of the guided OAM mode OAM_{-1,1}_{^{left}} from the input to the output of the optical fiber 4, the latter is configured to excite two further guided modes TE₀₁ and TM₀₁, because they also belong to modes group 1 defined by the guided linear mode LP_{1,1}: therefore part of the energy of the input optical signal carried by the guided OAM mode OAM_{-1,1}_{^{left}} is also transferred over the two guided modes TE₀₁ and TM₀₁.

For the purposes of explaining the disclosure, for the sake of simplicity it is assumed that the attenuation of the optical signal is disregarded during propagation from the input to the output of the optical fiber 4 and that thus the energy of the optical signal injected at the input of the fiber is preserved when distributed over the different guided modes belonging to the same group.

Therefore the optical fiber 4 is configured to propagate the first input optical signal from the input to the output in a first group of modes GM1_g composed of the guided OAM mode OAM_{-1,1}_{^{left}}, of the further guided OAM mode OAM_{+1,1}_{^{right}} and of the further guided modes TE₀₁ and TM₀₁; in the case of weakly guiding approximation, the first group of guided modes GM1_g is the guided linear mode LP_{1,1}.

The optical demultiplexing device 10 comprises an optical demultiplexing device 2 and an optical element 6 of the diffractive type.

Let's consider that the optical demultiplexing device 10 is positioned in a space defined by a Cartesian coordinate system (x, y, z), wherein the axis z corresponds to the direction of propagation of the optical beams and thus it represents the axis of the optical demultiplexing device 10, whereas the plane (x, y) is perpendicular to the axis z (and thus it is perpendicular to the axis of the optical demultiplexing device 10).

The optical demultiplexing device 2 has the function of performing the demultiplexing of a superposition of guided OAM modes with a different orbital angular momentum (that is, with different values l₁, l₂, l₃ . . . of the angular index l), that is of spatially dividing the free space optical beam incident on the optical demultiplexing device 2 into a plurality of free space optical beams associated with the plurality of different guided OAM modes; this is achieved by means of the generation of a plurality of free space optical beams oriented towards different directions in the space depending on the value and sign of the angular index l of the guided OAM mode at the output of the optical fiber 4.

The term “direction in the space” is understood as the direction identified by a reference point on the optical demultiplexing device 2 and a point external to it having three coordinates (x, y. z) in the case that a Cartesian coordinate system is considered; alternatively, the direction is identified by the reference point and an external point having three coordinates (p, φ, z) in the case in which a reference system with cylindrical coordinates is considered.

Considering the example in FIG. 1A, the optical fiber 4 generates at the output a free space optical beam FO1_SL that is generated from the optical signal of the first group of guided modes GM1_g at the output of the optical fiber 4; therefore the free space optical beam FO1_SL contains the information associated with the two values for the orbital angular momentum l=−1 and l=+1, of the two guided OAM modes OAM_{-1,1}_{^{left}} and OAM_{+1,1}_{^{right}}, respectively, and it contains the information associated with the two guided modes TE₀₁ and TM₀₁ (keep in mind that the guided modes TE₀₁ and TM₀₁ are the linear combination of the guided OAM modes of the OAM_{+1,1}_{^{left}} and OAM_{-1,1}_{^{right}} type).

Subsequently, the optical demultiplexing device 2 generates at the output two free space optical beams, FO3.1_SL and FO3.2_SL, wherein:

the free space optical beam FO3.1_SL has a first direction in the space depending on the absolute value (1) and sign (positive) of the angular index of l=+1 of the guided OAM mode of the OAM_{+1,1}_{^{right}} type and of the guided OAM mode of the OAM_{+1,1}_{^{left}} type (this latter being the contribution of the guided modes TE₀₁ and TM₀₁), as shown schematically in FIG. 1A;

the further free space optical beam FO3.2_SL has a second direction in the space (differing from the first direction) depending on the absolute value (1) and sign (negative) of the angular index of l=−1 of the guided OAM mode of the OAM_{-1,1}_{^{left}} type and of the guided OAM mode of the OAM_{-1,1}_{^{right}} type (this latter being the contribution of the guided modes TE₀₁ and TM₀₁), as shown schematically in FIG. 1A.

The diffractive optical element 6 has the function of collecting most of the energy of the optical signal that has been distributed (during propagation in the optical fiber 4) over the different guided OAM modes of the respective group to which the guided OAM mode considered belongs; moreover, the diffractive optical element 6 has the function of collimating the optical signal associated with each group of modes in a respective point in the space positioned on the detection surface of a photo-detector 5.

The photo-detector 5 (e.g. a CCD screen) is positioned at the far-field distance from the diffractive optical element 6 and it performs a conversion of the received optical signal associated with each group of modes into a respective electrical signal.

Moreover, the diffractive optical element 6 has the function of suitably reshaping the optical beam incident on it, so as to create a point of light on the photo-detector 5 with a suitable distribution of the luminous intensity.

Considering once again in particular the example in FIG. 1A, the diffractive optical element 6 is configured to receive at the input on a first zone 6-1 the free space optical beam FO3.1_SL having a first direction in the space and it is configured to generate, as a function of the free space optical beam FO3.1_SL, a collimated free space optical beam FO4.1_CL of the far-field type converging into a point P1 in the space, generating a point of light which is detected by the photo-detector 5.

Moreover, the diffractive optical element 6 is configured to receive at the input on a second zone 6-2 (different from the first zone 6-1) the further free space optical beam FO3.2_SL having a second direction in the space (different from the first direction) and it is configured to generate, as a function of the further free space optical beam FO3.2_SL, a further collimated free space optical beam FO4.2_CL of the far-field type converging into the same point P1 in the space, generating a point of light which is detected by the photo-detector 5.

The photo-detector 5 thus detects in point P1 both the point of light associated with the guided OAM mode OAM_{+1,1}_{^{right}} that has actually been injected into the optical fiber 4 and, in the same point P1, it detects the points of light associated with the guided OAM modes of the OAM_{-1,1}_{^{left}}, OAM_{+1,1}_{^{left}}, OAM_{-1,1}_{^{right}} type (the last two forming the guided modes TE₀₁ and TM₀₁), which also belong to the same group of modes (and which have been excited in the optical fiber 4 due to channel crosstalk).

In one embodiment, the optical demultiplexing device 10 further comprises a lens 3 interposed between the output of the optical fiber and the input of the optical demultiplexing device 2.

The lens 3 is of the converging type and it has the function of collimating the free space optical beam (e.g. FO1_SL and FO2_SL) generated from the optical signals of the groups of guided modes at the output of the optical fiber 4.

In one embodiment, the optical demultiplexing device 10 further comprises a lens 2-4 interposed between the output of the optical demultiplexing device 2 and the input of the diffractive optical element 6.

The lens 2-4 is a converging type of lens and it has the function of collimating the two free space optical beams FO3.1_SL, FO3.2_SL at the output of the optical demultiplexing device 2 in the two respective zones 6-1, 6-2 of the diffractive optical element 6.

In one embodiment, the optical demultiplexing device 10 further comprises a lens 2-5 interposed between the output of the diffractive optical element 6 and the photo-detector 5.

The lens 2-5 is a converging type of lens and it has the function of collimating the two free space optical beams FO4.1_CL, FO4.2_CL at the output of the two respective zones 6-1, 6-2 of the diffractive optical element 6.

The above considerations concerning FIG. 1A are applicable in a similar manner to FIG. 1B, with the following differences:

in the optical fiber 4, a second optical signal is further injected into the guided OAM mode M2_g having an angular index l=2, a radial index p=1 and a levorotatory circular state of polarization, which shall be indicated herein below as OAM_{+2,1}_{^{left}}, which belongs to modes group 2 defined by the guided linear mode LP_{2,1} (see Table 1);

during propagation of the guided OAM mode OAM_{+2,1}_{^{left}} from the input to the output of the optical fiber 4, the latter is configured to further excite also the further three guided OAM modes of group 2, which are OAM_{-2,1}_{^{right}}, OAM_{-2,1}_{^{left}}, OAM_{+2,1}_{^{right}};

at the output of the optical fiber, both the first optical signal has been propagated over the group of modes GM1_g as illustrated previously in the description of FIG. 1A, and the second optical signal has been propagated over the group of modes GM2_g which is composed of the guided OAM mode OAM_{+2,1}_{^{left}} and of the other three guided OAM modes which are OAM_{-2,1}_{^{right}}, OAM_{-2,1}_{^{left}} and OAM_{+2,1}_{^{right}}, wherein in case of weakly guiding approximation the second group of guided modes GM2_g is for example the guided linear mode LP_{2,1};

the optical fiber 4 generates at the output the optical beam FO5_SL which is generated by the overlapping of the optical signal of the first group of guided modes GM1_g and of the optical signal of the second group of guided modes GM2_g;

the optical demultiplexing device 2 further generates at the output two free space optical beams FO7.1_SL, FO7.2_SL having a third and a fourth direction in the space, respectively, different from the first and second direction in the space of the optical beams FO3.1_SL, FO3.2_SL, wherein the third and the fourth direction in the space of the optical beams FO7.1_SL, FO7.2_SL depend on the absolute value and sign of the angular indices l of the guided OAM modes OAM_{+2,1}_{^{left}}, OAM_{-2,1}_{^{right}}, OAM_{-2,1}_{^{left}}, OAM_{+2,1}_{^{right}}, wherein the free space optical beam FO7.1_SL carries the information associated with the two guided modes OAM_{+2,1}_{^{left}}, OAM_{+2,1}_{^{right}} having the same absolute value (2) and same positive sign of the angular index (i.e., l=+2) and having a different state of polarization, whereas free space optical beam FO7.2_SL carries the information associated with the two guided modes OAM_{-2,1}_{^{left}} and OAM_{-2,1}_{^{right}} having the same absolute value (2) and negative sign of the angular index (i.e., l=−2) and having a different state of polarization (or, vice versa, the free space optical beam FO7.2_SL carries the information associated with the two guided modes OAM_{+2,1}_{^{left}}, OAM_{+2,1}_{^{right}} having an angular index of l=+2 and a different state of polarization, whereas the free space optical beam FO7.1_SL carries the information associated with the two guided modes OAM_{-2,1}_{^{left}}, OAM_{-2,1}_{^{right}} having an angular index of l=−2 and a different state of polarization);

the diffractive optical element 6 receives at the input on the zone 6-3 (different from zones 6-1, 6-2) the free space optical beam FO7.1_SL having the third direction in the space and generates at the output, as a function of the free space optical beam FO7.1_SL, a third collimated free space optical beam FO8.1_CL at the far-field distance, which converges into point P2 (different from P1) in the space generating a point of light, which is detected by the photo-detector 5;

the diffractive optical element 6 receives at the input on the zone 6-4 (different from zones 6-1, 6-2, 6-3) the free space optical beam FO7.2_SL having the fourth direction in the space and generates at the output, as a function of the free space optical beam FO7.2_SL, a fourth collimated free space optical beam FO8.2_CL at the far-field distance, which also converges into point P2 in the space generating a point of light, which is detected by the photo-detector 5.

Therefore, the photo-detector 5 further detects in point P2 both the point of light associated with the guided OAM mode OAM_{+2,1}_{^{left}} which has actually been injected into the optical fiber 4 and detects in the same point P2 the points of light associated with the three guided OAM modes (OAM_{+2,1}_{^{right}}, OAM_{-2,1}_{^{right}}, OAM_{-2,1}_{^{left}}) also belonging to the same modes group 2 (and which have been excited in the optical fiber 4 due to channel crosstalk).

Note that the preceding description of FIG. 1B concerning the case of guided OAM modes with an angular index of l=2 of the step-index fibers, LP_{2,1}, can be repeated in a similar manner for any other group of guided OAM modes Lp_{1,1} having another value of the angular index, l, so as to generate a corresponding point of light Pₗ on the photo-detector 5.

Therefore, every optical signal that is transmitted by a group of modes is collected by the photo-detector 5 in different points and the above described demultiplexing can be carried out by the optical system simultaneously for different optical signals.

In other words, the previous considerations for FIG. 1B concerning two optical signals carried by two groups of guided OAM modes M1_g, M2_g are applicable more in general to a plurality of optical signals carried by a respective plurality of groups of guided OAM modes.

In this case, the optical fiber 4 is configured to carry simultaneously a plurality of optical signals over a respective plurality of groups of guided OAM modes M1_g, M2_g, M3_g, . . . .

Moreover, the optical fiber 4 is configured to generate at the output the optical beam FO5_SL which is generated by the overlapping of optical signals of the plurality of groups of guided OAM modes M1_g, M2_g, M3_g, . . . .

Lastly, the optical demultiplexing device 2 is configured to receive from the optical fiber 4 the optical beam FO5_SL and it is configured to generate, as a function thereof, a plurality of collimated free space optical beams converging on the photo-detector 5 in a respective plurality of different points P1, P2, P3, . . . .

In one embodiment, the diffractive optical element 6 is implemented with a diffraction grating with a spatially variable period.

Said diffraction grating is configured to receive at the input on different zones a plurality of free space optical beams (which are FO3.1_SL, FO3.2_SL in FIG. 1A, or FO7.1_SL, FO7.2_SL in FIG. 1B) associated with degenerate or quasi-degenerate guided modes belonging to the same group of modes and it is designed so as to transmit said plurality of free space input optical beams towards respective directions converging into a same point in the space, that is point P1 in FIG. 1A in the considered case of a single group of modes and points P1, P2 in FIG. 1B in the considered case of two groups of modes, and more in general into a plurality of points P1, P2, P3, . . . in the generic case of a plurality of guided OAM modes with a different values for the angular momentum l.

Alternatively, said diffraction grating is designed so as to reflect (instead of transmitting) said plurality of free space input optical beams (associated with degenerate or quasi-degenerate guided modes belonging to the same group of modes) towards respective directions converging into a same point in the space.

In one embodiment, the diffractive optical element 6 includes an anisotropic curvature term, which differs over two perpendicular directions, having the function of focusing the optical signal carried by the plurality of free space input optical beams of the same group of modes to the same point in the space and it also has the function of suitably shaping the profile of the points of light generated by the plurality of optical beams focused to the same point in space.

In one embodiment, the phase function of the diffractive optical element 6 implemented with the diffraction grating with a spatially varying period is the following:

$$φ ( x , y ) = {\sum }_{l = - {l}_{max}}^{{l}_{max}} rect ( \frac{x - {x}_{l}}{Δ x} ) rect ( \frac{y - {y}_{l}}{Δ y} ) {γ}_{l} y$$

wherein the function rect( ) is thus defined:

rect(t)=1, for −1/2<t<1/2,

rect(t)=0|t|>1/2,

and wherein:

k=2π/λ is the wave vector,

xₗ and yₗ are the coordinates of the centre of the incident point of light relating to the value l,

Δx and Δy are design parameters defining the lateral dimensions of the areas with a constant period and they are of dimensions such to contain the incident point of light,

γₗ is a parameter that adjusts the deviation of the beams transmitted from the zone relative to the value l.

The aim of the embodiment described is to collect into one same point in far field beams that illuminate areas relating to opposite values of l, thus:

γₗ=γ₋ₗ

In one embodiment, a converging lens 2-5 is interposed between the diffractive optical element 6 and the photo-detector 5 and it has the function of converging beams relating to opposite values of l into the same point having coordinate

$${s}_{l} = \frac{{γ}_{l} {f}_{3}}{k}$$

along the linear array of points, wherein f₃ is the focal distance of the lens 2-5.

Alternatively, the lens 2-5 can be integrated in the diffractive optical element 6, having the following phase function which further comprises a focus term:

$$φ ( x , y ) = {\sum }_{l = - {l}_{max}}^{{l}_{max}} rect ( \frac{x - {x}_{l}}{Δ x} ) rect ( \frac{y - {y}_{l}}{Δ y} ) {γ}_{l} y + k \frac{{x}^{2} + {y}^{2}}{2 {f}_{3}}$$

More generally, the focus term of the phase function of the diffractive optical element 6 can be anisotropic, particularly when it is necessary to reshape the beam by means of different curvature terms in the two directions x-y:

$$φ ( x , y ) = {\sum }_{l = - {l}_{max}}^{{l}_{max}} rect ( \frac{x - {x}_{l}}{Δ x} ) rect ( \frac{y - {y}_{l}}{Δ y} ) {γ}_{l} y + k \frac{{y}^{2}}{2 {f}_{3}} + k \frac{{x}^{2}}{2 {f}_{4}}$$

Alternatively, for example in the case of graded-index fibers wherein OAM modes with a different modulus of the l value belong to the same group of quasi-degenerate modes, it is possible to associate the same value of the γ parameter to different l values, so as to collimate the beams relative to the same group on the same point of the photo-detector 5.

In one embodiment, the optical demultiplexing device 2 of the first embodiment of the disclosure is realized with a first diffractive optical element 2-1 and a second diffractive optical element 2-2.

Referring in particular to the example in FIG. 1A, the first diffractive optical element 2-1 is configured to receive at the input the free space optical beam FO1_SL transmitted (and suitably collimated and shaped) at the output of the optical fiber 4 and it is configured to generate at the output, as a function of the incident free space optical beam FO1_SL, an internal free space optical beam FO2_SL having a propagation direction substantially equal to that of the incident free space optical beam FO1_SL, wherein the propagation direction of the free space optical beams FO1_SL, FO2_SL coincides with the direction of the axis z of the optical demultiplexing device 10; subsequently, the second diffractive optical element 2-2 is configured to receive at the input the internal free space optical beam FO2_SL and it is configured to generate at the output, as a function of the incident internal free space optical beam FO2_SL, the two free space optical beams FO3.1_SL, FO3.2_SL having two different directions in the space, as explained hereinabove.

In a similar manner, referring particularly to the example in FIG. 1B, the first diffractive optical element 2-1 is configured to receive at the input the free space optical beam FO5_SL transmitted, suitably collimated and shaped, at the output by the optical fiber 4 and it is configured to generate at the output, as a function of the incident free space optical beam FO5_SL, an internal free space optical beam FO6_SL having a propagation direction substantially equal to that of the incident free space optical beam FO5_SL, wherein the direction of propagation of the free space optical beams FO5_SL and FO6_SL coincides with the direction of the axis z of the optical demultiplexing device 10; subsequently, the second diffractive optical element 2-2 is configured to receive at the input the internal free space optical beam FO6_SL and it is configured to generate at the output, as a function of the incident internal free space optical beam FO6_SL, the two free space optical beams FO7.1_SL, FO7.2_SL having two different directions in space, as explained hereinabove.

In one embodiment, a lens 2-3 is interposed between the first diffractive optical element 2-1 and the second diffractive optical element 2-2.

In one embodiment, according to a first variant of the first embodiment of the disclosure, the set of the first diffractive optical element 2-1 and of the second diffractive optical element 2-2 implements an geometric optical transformation of the log-pol type, as defined in the article by G. C. G. Berkhout, M. P. J. Lavery, J. Courtial, M. W. Beijersbergen, M. J, Padgett, “Efficient sorting of orbital angular momentum states of lights”, in Phys. Rev. Lett. 105, 153601-1-4 (2010).

The first diffractive optical element 2-1 (also indicated as an “unwrapper”) has the function of performing a conformal mapping from a circular distribution to a linear distribution of luminous intensity, as shown schematically in FIG. 1A.

The second diffractive optical element 2-2 (also indicated as a “phase corrector”) has the function of performing a phase correction.

In particular, the first diffractive optical element 2-1 implements a change in coordinates from polar coordinates (r, φ) in the input plane to rectangular coordinates (x, y) in the output plane by means of the following mapping:

$$x = - a ln \frac{r}{b}$$

$$y = a mod ( ϕ , 2 π )$$

wherein a and b are geometric parameters that can be defined independently.

Said geometric optical transformation of the log-pol type has the function of mapping the intensity distribution with azimuthal symmetry typical of the OAM modes in a linear intensity distribution, which is then focused to a far-field distance proportional to the orbital angular momentum l content.

The following is the phase function of the first diffractive optical element 2-1:

$${φ}_{1} ( x , y ) = \frac{2 π a}{λ {f}_{1}} [ y arctan ( \frac{y}{x} ) - x ln ( \frac{\sqrt{{x}^{2} + {y}^{2}}}{b} ) + x ]$$

The following is the phase function of the second diffractive optical element 2-2:

$${φ}_{2} ( x , y ) = - \frac{2 π ab}{λ {f}_{1}} [ exp ( - \frac{x}{a} ) cos ( \frac{y}{a} ) ]$$

wherein f₁ is the focal distance of the two diffractive optical elements 2-1, 2-2.

If a lens 2-4 having a focal distance f₂ is positioned after the second diffractive optical element 2-2, the result on the detecting surface of the photo-detector 5 positioned at the far-field distance is as follows.

Once the wavelength λ of the optical beam incident on the first diffractive optical element 2-1 is fixed, the position yₗ at the far-field distance of the point of light is directly proportional to the value of the angular index l according to the following formula:

$${y}_{l} = \frac{λ {f}_{2}}{2 π a} l .$$

Note that in the above formula the direct proportionality of the position of the point of light allows to obtain the function of demultiplexing a set of overlapped optical beams having different angular momentum values.

The diffractive optical element 6 used in the first variant of the first embodiment of the disclosure (that is, using the geometric optical transformation of the log-pol type) has the function of suitably reshaping the optical beam incident on it and having an elongated luminous intensity distribution, so as to create a point of light on the photo-detector 5 with circular symmetry of the luminous intensity distribution.

In one embodiment, according to a second variant of the first embodiment of the disclosure, the first diffractive optical element 2-1 and the second diffractive optical element 2-2 of the first variant (i.e., that use the geometric optical transformation of the log-pol type) are implemented with a respective holographic mask having continuous phase values ranging between 0 and 2π (π is the constant Greek pi equal to 3.1415) and also known as a kinoform lens.

Alternatively, according to a third variant of the first embodiment of the disclosure, the first diffractive optical element 2-1 and the second diffractive optical element 2-2 of the first variant (i.e., that use the geometric optical transformation of the log-pol type) are implemented with a respective holographic mask having the structure of a multi-level surface, that is composed of a plurality of pixels (that is, a matrix of pixels), each pixel having discrete phase and/or amplitude values.

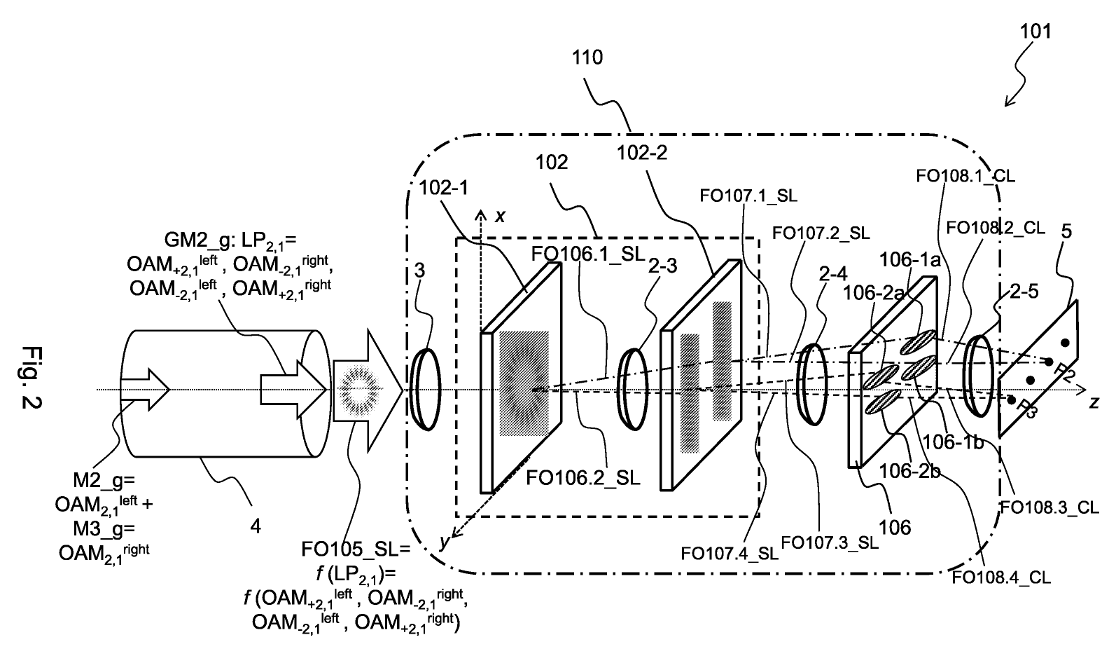

According to a second embodiment of the disclosure shown in FIG. 2, the optical communication system 101 (in particular, the optical device 110) has not only the function of performing the demultiplexing of guided OAM modes with a different orbital angular momentum, but also the function of performing polarization division demultiplexing (PDM=polarization division multiplexing).

In particular, the optical device 110 of the second embodiment has a function similar to that of the optical device 10 of the first embodiment, with the difference that it has the function of performing the demultiplexing of guided OAM modes with a different orbital angular momentum and a different state of polarization, recovering at the same time, for each group of guided modes, most of the energy of the optical signal that has been distributed over the different guided OAM modes of the respective group of degenerate or quasi-degenerate modes to which the considered guided OAM mode belongs.

In a similar manner, the optical demultiplexing device 102 of the second embodiment has a function similar to that of the optical demultiplexing device 2 of the first embodiment, with the difference that the optical demultiplexing device 102 is capable of distinguishing between two guided OAM modes having the same angular index value l and a different state polarization; therefore the optical demultiplexing device 102 is capable of performing the demultiplexing of a superposition of guided OAM modes with a different orbital angular momentum and a different state of polarization.

Moreover, the diffractive optical element 106 of the second embodiment has a function similar to that of the diffractive optical element 4 of the first embodiment, with the difference that it comprises at least four zones 106-1a, 106-1b, 106-2a, 106-2b organized into two pairs arranged in column, wherein the first pair of zones 106-1a, 106-1b is configured to receive the two free space optical beams FO107.1_SL, FO107.2_SL, respectively, having the same state of polarization (e.g. left), whereas the second pair of zones 106-2a, 106-2b is configured to receive the two free space optical beams FO107.3_SL, FO107.4_SL, respectively, having a different state of polarization (right, in the considered example) with respect to the two free space optical beams FO107.1_SL, FO107.2_SL.

Referring in particular to the example shown in FIG. 2, let's consider a multimode optical fiber 4 capable of maintaining a substantially unchanged state of polarization of the guided modes during propagation along the optical fiber 4, that is capable of significantly reducing crosstalk between degenerate or quasi-degenerate modes belonging to the same group of modes, but having perpendicular states of polarization.

Let's consider also group 2 of guided modes in Table 1, in which the following two subgroups having a different state of polarization can be identified:

a first subgroup is composed of guided OAM modes of the OAM_{+2,1}_{^{left}} and OAM_{-2,1}_{^{left}} type, that is having the same levorotatory circular state of polarization and having an angular index with the same absolute value (2) and opposite sign (±2);

a second subgroup is composed of guided OAM modes of the OAM_{+2,1}_{^{right}} and OAM_{-2,1}_{^{right}} type, that is having the same dextrorotatory circular state of polarization and having an angular index with the same absolute value (2) and opposite sign (±2).

In the optical fiber 4, a first optical signal is injected into the guided mode OAM_{+2,1}_{^{left}} having an angular index l=2, a radial index p=1 and a levorotatory circular state of polarization and belonging to the first subgroup of group 2 in Table 1; moreover, in the optical fiber 4, a second optical signal is injected into the guided mode OAM_{+2,1}_{^{right}} having an angular index l=+2, a radial index p=1 and a dextrorotatory circular state of polarization and belonging to the second subgroup of group 2.

In this case, the optical fiber 4 is thus such to carry at the input the information on two channels associated with the guided modes OAM_{+2,1}_{^{left}} and OAM_{+2,1}_{^{right}} respectively, having the same angular index value l=+2 and opposite circular polarization.

During propagation of the guided OAM mode of the OAM_{+2,1}_{^{left}} type in the optical fiber 4, the guided OAM mode of the OAM_{-2,1}_{^{left}} type is also excited which also belongs to the first subgroup of group 2 of guided modes; furthermore, during propagation in the optical fiber 4 of the guided OAM mode of the OAM_{+2,1}_{^{right}} type, the guided OAM mode of the OAM_{-2,1}_{^{right}} type is also excited which also belongs to the second subgroup of group 2 of guided modes.

The optical device 110 performs the demultiplexing of the guided OAM modes OAM_{+2,1}_{^{left}} and OAM_{+2,1}_{^{right}} and furthermore it recovers most of the energy of the first optical signal that has been distributed also in the guided mode OAM_{-2,1}_{^{left}} belonging to the first subgroup of group 2 and it recovers most of the energy of the second optical signal that has been distributed also in the guided mode OAM_{-2,1}_{^{left}} belonging to the second subgroup of group 2.

In particular, the optical demultiplexing device 102 generates at the output four free space optical beams FO107.1_SL, FO107.2_SL, FO107.3_SL, FO107.4_SL, having a first, second, third and fourth direction in the space, respectively, depending on the value and sign of the angular indices l and on the state of polarization of the guided OAM modes OAM_{+2,1}_{^{left}}, OAM_{-2,1}_{^{right}}, OAM_{-2,1}_{^{left}}, OAM_{+2,1}_{^{right}}, respectively, wherein:

the free space optical beam FO107.1_SL has a first direction in the space depending on the value and sign of the angular index l=+2 and on the levorotatory circular state of polarization of the guided OAM mode of the OAM_{+2,1}_{^{left}} type;

the free space optical beam FO107.2_SL has a second direction in the space (differing from the first direction) depending on the value and sign of the angular index l=−2 and on the levorotatory circular state of polarization of the guided OAM mode of the OAM_{-2,1}_{^{left}} type;

the free space optical beam FO107.3_SL has a third direction in space (differing from the first and second direction) depending on the value and sign of the angular index l=−2 and on the dextrorotatory circular state of polarization of the guided OAM mode of the OAM_{-2,1}_{^{right}} type;

the free space optical beam FO107.4_SL has a fourth direction in space depending on the value and sign of the angular index l=+2 and on the dextrorotatory circular state of polarization of the guided OAM mode of the OAM_{+2,1}_{^{right}} type.

Moreover, the diffractive optical element 106 is configured to:

receive at the input on a first zone 106-1a the free space optical beam FO107.1_SL having a first direction in the space and generate at the output, as a function of the incident free space optical beam FO107.1_SL, a collimated free space optical beam FO108.1_CL of the far-field type converging into a point P2 in the space, generating a point of light, which is detected by the photo-detector 5;

receive at the input on a second zone 106-1b, the free space optical beam FO107.2_SL having a second direction in the space (different from the first direction) and generate at the output, as a function of the free space optical beam FO107.2_SL, a collimated free space optical beam FO108.2_CL of the far-field type, which also converges into point P2 in space, generating a point of light, which is detected by the photo-detector 5;

receive at the input on a third zone 106-2a, the free space optical beam FO107.3_SL having a third direction in the space (different from the first and second direction) and generate at the output, as a function of the free space optical beam FO107.3_SL, a collimated free space optical beam FO108.3_CL of the far-field type that converges into a point P3 (different from P2) in the space, generating a point of light, which is detected by the photo-detector 5;

receive at the input on a fourth zone 106-2b, the free space optical beam FO107.4_SL having a fourth direction in the space (different from the first, second and third direction) and generate at the output, as a function of the free space optical beam FO107.4_SL, a collimated free space optical beam FO108.4_CL of the far-field type, which also converges into point P3 in the space, generating a point of light, which is detected by the photo-detector 5.

Therefore in point P2 it is detected the first optical signal that was injected into the guided mode OAM_{+2,1}_{^{left}} having an angular index of l=+2 and levorotatory circular polarization, whereas in point P3 it is detected the second optical signal that was injected into the guided mode OAM_{+2,1}_{^{right}} having the same angular index value of l=+2, but a different dextrorotatory circular polarization.

In one embodiment, the optical demultiplexing device 102 is implemented with two optical elements 102-1 and 102-2 similar to the optical elements 2-1 and 2-2, respectively.

In this case, the first diffractive optical element 102-1 is configured to receive at the input the free space optical beam FO105_SL transmitted at the output by the optical fiber 4 and it is configured to generate at the output, as a function of the incident free space optical beam FO105_SL, a first and a second internal free space optical beam FO106.1_SL and FO106.2_SL, wherein:

the first internal free space optical beam FO106.1_SL has a first propagation direction depending on the absolute value (2) of the angular index l and on its state of polarization (e.g. left) and thus it is directed towards a first area of the second diffractive optical element 102-2 (as shown schematically in FIG. 2);

the second internal free space optical beam FO106.2_SL has a second propagation direction depending on the absolute value (2) of the angular index l and on the different state of polarization thereof with respect to that of the first internal free space optical beam FO106.1_SL (in the example, right) and thus it is directed towards a second area (different from the first) of the second diffractive optical element 102-2 (as shown schematically in FIG. 2).

Subsequently, the second diffractive optical element 102-2 is configured to receive at the input the first internal free space optical beam FO106.1_SL and it is configured to generate therefrom at the output the two free space optical beams FO107.1_SL, FO107.2_SL having two different directions in the space depending on the two different values of the angular index l=±2 and on the same state of polarization (in the example considered, left), as above explained; moreover, the second diffractive optical element 102-2 is configured to receive at the input the second internal free space optical beam FO106.2_SL and it is configured to generate therefrom at the output the two free space optical beams FO107.3_SL, FO107.4_SL having two different directions in the space depending on the two different values of the angular index of l=±2 and on the same state of polarization (in the considered example, right) different from that of the two free space optical beams FO107.1_SL, FO107.2_SL, as above explained.

In one embodiment, the optical demultiplexing device 110 performs the polarization demultiplexing using the first diffractive optical element 102-1 and the second diffractive optical element 102-2 in a manner similar to that indicated for the first diffractive optical element 2-1 and for the second diffractive optical element 2-2 of the first, second or third variant of the first embodiment, that is using the geometric optical transformation of the log-pol type and implementing it with a plurality of pixels; moreover, the first diffractive optical element 102-1 and the second diffractive optical element 102-2 are implemented with Pancharatnam-Berry optical elements.

More specifically, the single pixel is realized in the form of a digital grating with a period smaller than the wavelength and an orientation proportional to the phase; in this way the the phase term is not due to the optical path of the wave inside the material, but it is due to local manipulation of the polarization state of the incident wave and it is linked to the space-variant Pancharatnam-Berry phase.

The gratings have their orientation and the effect on the incident electromagnetic wave depends on the angle formed by the grating with respect to the polarization plane.

Let's give a set of pixels of a lateral dimension L²>λ*d and such that every pixel is formed by a grating of a period Λ<<λ and that it has an orientation defined by the angle θ, wherein the lens is implemented in the form of a matrix of pixels.

The transmission function T of the lens is a function that depends on the Cartesian coordinates of the single pixel:

T(x,y)=R(x,y)τ(x,y)R⁻¹(x,y)

wherein:

$$R ( x , y ) = ( \begin{matrix}cos θ ( x , y ) & - sin θ ( x , y ) \\ sin θ ( x , y ) & cos θ ( x , y )\end{matrix} )$$

is the local rotation matrix and

$$τ = ( \begin{matrix}{e}^{- i δ / 2} & 0 \\ 0 & {e}^{+ i δ / 2}\end{matrix} )$$

is the Jones matrix of the single pixel.

This matrix describes a birefringence effect wherein the phase delay δ is determined by the geometry of the grating, as a function of the period of the grating and of the ratio between the line width and space, and it also depends on the refractive index of the substrate material.

The angle θ represents the orientation of the grating of every pixel.

Assuming that the period and amplitude are constant for every pixel and that only the orientation of the angle θ changes, the matrix proves to be spatially dependent only on the orientation of the pixels.

Therefore, the following is the T matrix:

$$T = ( \begin{matrix}{e}^{- i δ / 2} {cos}^{2} θ + {e}^{+ i δ / 2} {sin}^{2} θ & - i sin ( 2 θ ) sin ( δ / 2 ) \\ - i sin ( 2 θ ) sin ( δ / 2 ) & {e}^{+ i δ / 2} {cos}^{2} θ + {e}^{- i δ / 2} {sin}^{2} θ\end{matrix} )$$

For dextrorotatory circular R and levorotatory circular L polarizations, the T matrix operates as follows:

T[R]=cos (δ/2)R−i sin (δ/2)e^{+2iθ}L

T[L]=cos (δ/2)L−i sin (δ/2)e^{-2iθ}R

The resulting wave is composed of two components: the zero order and the diffracted order.

The zero order has the same polarization as the incident wave and is not affected by any phase modification.

The order of diffraction has polarization perpendicular to that of the input wave and its phase at each point is proportionally equal to twice the local rotation angle of the grating.

In the case wherein δ=π, the grating provides pure phase modulation and total conversion of the polarization, with the phase of the propagating wave being equal to twice the rotation angle.

Therefore, the effect is the following;

T[R]=HL

T[L]=−H*R

wherein H is the resulting transmission function of the optical element and H* the complex conjugate.

Therefore, the desired phase modulation can be achieved by simply varying the orientation of the grating of each pixel, and phase modulation can be achieved by using a simple binary grating, eliminating the need for complicated multi-pitch gratings or continuous or multi-level phase masks.

In other words, the first diffractive optical element 102-1 and the second diffractive optical element 102-2 are implemented with Pancharatnam-Berry optical elements that allow to perform both mode division demultiplexing and polarization division demultiplexing (known as PDM=Polarization Division Multiplexing).

The optical elements 102-1, 102-2 of the second embodiment implemented with pixels of digital gratings with a period smaller than the wavelength are intrinsically affected by the dextrorotatory or levorotatory circular state of polarization of the incident optical beam.

In particular, in the case of a dextrorotatory circular state of polarization σ+, the first diffractive optical element 102-1 and the second diffractive optical element 102-2 of the second embodiment impart a phase shift to the optical beam incident on them based on the following phase functions, respectively:

$${φ}_{1} ( x , y ) = \frac{2 π a}{λ {f}_{1}} [ y arctan ( \frac{y}{x} ) - x ln ( \frac{\sqrt{{x}^{2} + {y}^{2}}}{b} ) + x ]$$

$${φ}_{2} ( x , y ) = [ - \frac{2 π ab}{λ {f}_{1}} exp ( - \frac{x}{a} sgn x ) cos ( \frac{y}{a} ) + α x + β y ]$$

wherein sgn(x)=1 for x>0, sgn(x)==−1 for and wherein the parameters (α, β) control the position of the array of the points of light generated on the photo-detector 5.

In the case of a levorotatory circular state of polarization σ−, the first diffractive optical element 102-1 and the second diffractive optical element 102-2 impart a phase shift to the optical beam incident on them based on the following phase functions, respectively:

$${φ}_{1} ( x , y ) = \frac{2 π a}{λ {f}_{1}} [ - y arctan ( \frac{y}{x} ) + x ln ( \frac{\sqrt{{x}^{2} + {y}^{2}}}{b} ) - x ]$$

$${φ}_{2} ( x , y ) = [ \frac{2 π ab}{λ {f}_{1}} exp ( - \frac{x}{a} sgn x ) cos ( \frac{y}{a} ) - α x - β y ]$$

If a lens 2-4 having a focal distance f₂ is positioned after the second diffractive optical element 102-2, the following is the result on the detecting surface of the photo-detector 5 at the far-field distance.

Once the wavelength λ of the optical beam incident on the first diffractive optical element 102-1 is fixed, the position at the far-field distance of the point of light generated on the photo-detector 5 depends on the value of the angular index l according to the following coordinates (yₗ, xₗ):

$${y}_{l}^{\pm } = \pm \frac{λ {f}_{2}}{2 π} ( \frac{𝓁}{a} + β )$$

$${x}_{l}^{\pm } = \pm \frac{λ {f}_{2}}{2 π} α$$

wheren the “+” sign refers to the dextrorotatory circular state of polarization and the “−” sign refers to the levorotatory circular state of polarization.

According to the approximation of the effective medium, the refraction index of a linearly polarized wave, whose electric field is parallel or perpendicular to the grating vector, is given by the following, respectively:

n_{∥}²=qn₁²+(1−q)n₂²

n_{⊥}⁻²=qn₁⁻²+(1−q)n₂⁻²

wherein q=s/Λ is the ratio between the line width s and the period Λ and wherein n₁ and n₂ are the refraction index of the air and of the material constituting the grating at the considered wavelength.

The phase delay δ is as follows:

$$δ = \frac{2 π}{λ} d ( {n}_{∥} - {n}_{⊥} )$$

As a result, the depth d of the grating to achieve a phase delay equal to π is as follows:

$$d = \frac{λ}{2 ( {n}_{∥} - {n}_{⊥} )} .$$

The estimations of n_{∥} and n_{⊥} are valid for gratings whose periods are sufficiently smaller than the incident wavelength, at least Λ<λ/10. Otherwise, their value can be calculated with more rigorous numerical methods when the grating pitch is comparable to the wavelength.

The choice of the substrate material is strictly correlated with the working wavelength: the higher the refraction index, the smaller the amplitude of the grating needed to provide a phase delay equal to π and to obtain a pure phase with Pancharatnam-Berry optical elements.

Table 3 below reports the values for the thickness required for the various materials at the working wavelength in the visible range λ=633 nm.

TABLE 3

| λ = 633 nm, | | | |
|---|---|---|---|
| Line width | | d | Aspect |
| s = 60 nm | N | (μm) | ratio |
| BK7 glass | 1.52 | 3.011 | 50 |
| PMMA | 1.49 | 3.357 | 56 |
| ITO | 1.87 | 1.244 | 21 |
| ZnSe | 2.60 | 0.487 | 8.5 |
| ZnS | 2.34 | 0.634 | 10.6 |

Considering a grating with a period equal to about 60 nm, it should be noted that the aspect ratio of the grating (defined as the ratio between the depth and the line width) would be equal to 50 in the case of glass (BK7 glass)—such a high value could give rise to a problem involving a manufacturing process that would be extremely difficult to implement.

On the other hand, transparent materials with high refraction index values can lower the aspect ratio, thus providing more accessible fabrication conditions. ZnSe and ZnS are particularly indicated for reducing the aspect ratio to values around 10.

In the case of radiation typically used for transmission in telecommunication networks in the near-infrared, silicon becomes a transparent material and has a high refraction index: in this case the required thickness d of the grating is equal to about 500 nm, which corresponds to an aspect ratio of only 3-4, as shown in Table 4 below.

In the case of silicon nitride, the aspect ratio is about 10-15.

TABLE 4

| Silicon | | |
|---|---|---|
| Line width | d | Aspect |
| s = 150 nm | (μm) | ratio |
| λ = 1310 nm | 0.530 | 3.5 |
| λ = 1550 nm | 0.647 | 4.3 |
| Silicon nitride, s = 150 nm | | |
| λ = 1310 nm (n = 1.994) | 2.091 | 13.9 |
| λ = 1550 nm (n = 1.989) | 2.495 | 16.6 |

During the manufacturing process, it may be useful to have a map of optimal configurations of the parameters (d, q) providing phase delay δ=π for the given wavelength.

Assuming that n₁=n and n₂=1 (air), one obtains:

$$d = \frac{λ}{2} \frac{\sqrt{q + ( 1 - q ) {n}^{2}}}{\sqrt{{q}^{2} {n}^{2} + q ( 1 - q ) + q ( 1 - q ) {n}^{4} + {( 1 - q )}^{2} {n}^{2}} - n}$$

In this manner, maps of useful optimal configurations are obtained for identifying the best process windows for realizing the pixels of gratings.

The optical elements can be realized with high-resolution nanofabrication techniques, using a combination of techniques such as electronic lithography, high resolution ultraviolet light lithography for industrial production, etching with chemical/physical etching systems such as Reactive Ion Etching, imprinting lithography, evaporation processes and the combination thereof.

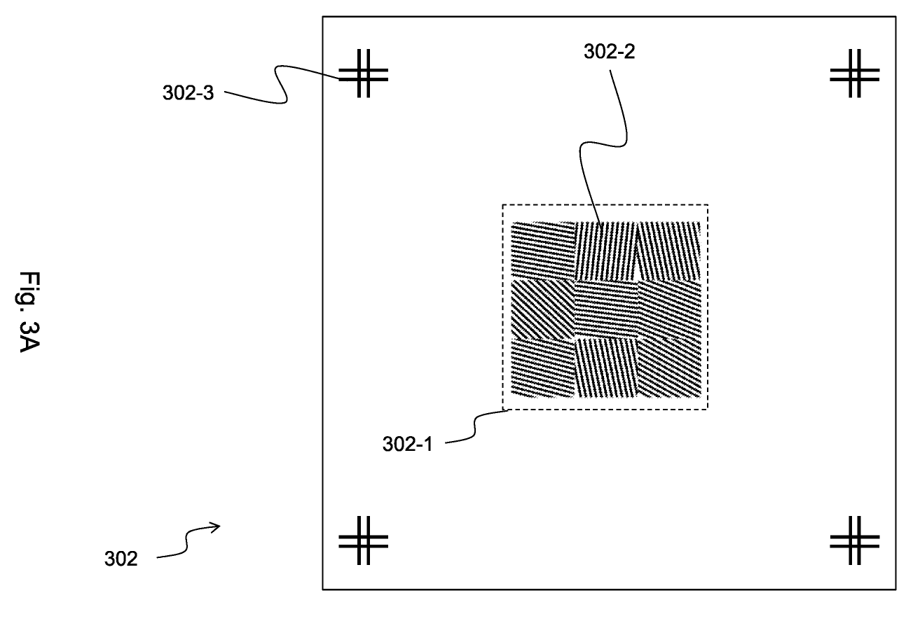

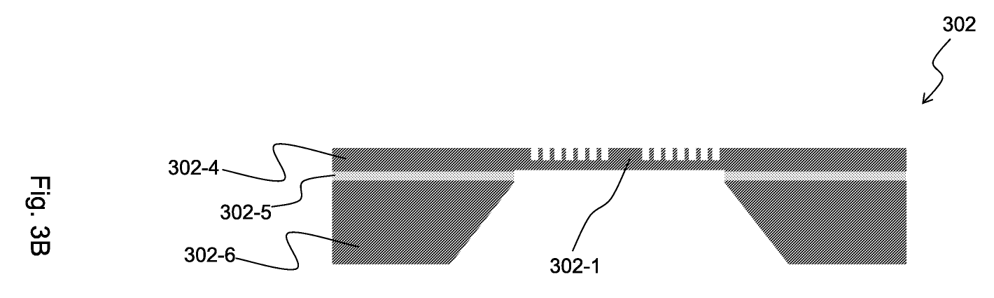

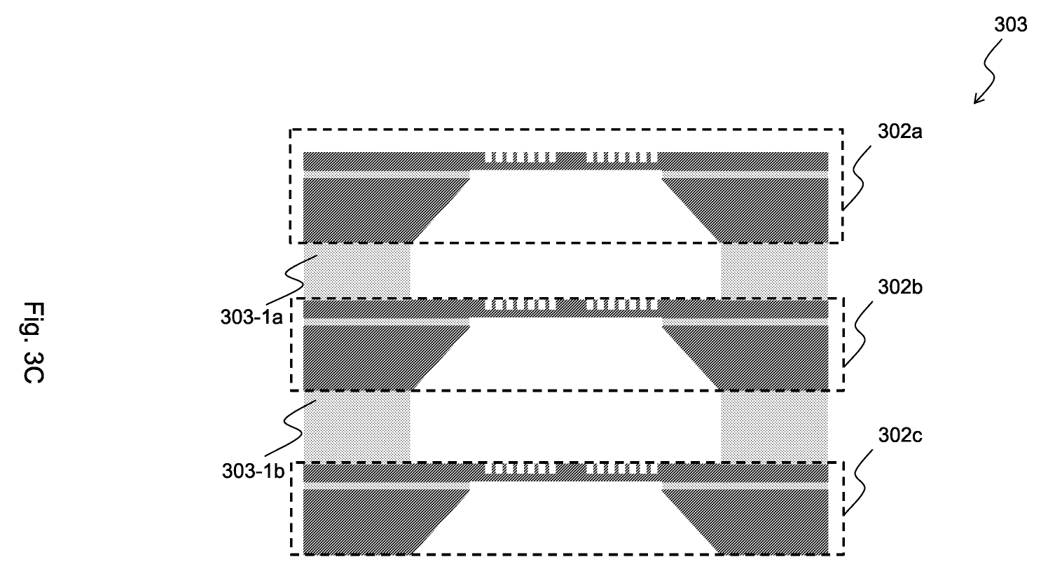

FIGS. 3A and 3B show a possible embodiment 302 by means of a free-standing silicon membrane 302-2. Starting from a crystalline silicon substrate 302-6 with a preferential orientation [001], a double layer composed of silicon oxide (SiO2) 302-5 is realized, over which a thickness of silicon 302-4 is deposited.

This structure is usually used in the manufacturing processes and it is called a silicon on insulator (SOI).

The thickness of the silicon must be greater than the depth of the etching to be done and, in particular, it must be of a thickness ranging between 2 μm and 5 μm.

In one embodiment, reference systems (markers) 302-3 are realized on the surface of the SOI and they serve to align the design of the optical element with the etching of the substrate and subsequently the optical elements with respect to each other.

The etching of the silicon and the SiO₂ substrate is carried out with chemical etching (wet-etching) from the backside according to known procedures at the zone where the gratings forming the considered optical element 302-1 are realized.

In one embodiment, the etching of the substrate at the membrane 302-2 takes place prior to the realization of the grating on the surface of the silicon.

One or more Pancharatnam-Berry gratings can be made on the surface of the silicon using high resolution resist lithography and, in particular, with etching processes defined as lift-off techniques according to the prior art, which comprise the evaporation of metals (e.g. chrome, thickness in particular 3-10 nm), etching of the deep zone of the grating with RIE techniques and removal of metals and the resist. It is essential that the etching be shallower than the thickness of the substrate so as to ensure sufficient mechanical stability enabling the membrane to be free-standing.

Alternatively, the Pancharatnam-Berry optical elements can be realized on silicon nitride membranes having a structure and lithographic methods similar to those described for the case of membranes made of silicon oxide.

Known manufacturing techniques allow to align different substrates with respect to each other.

It is sufficient to design reference markers during the realization of the single optical elements.

This method allows to realize optical devices, avoiding the manufacturing of high-cost refractive lenses and above all, the method allows to align the various optical components with respect to each other.

These markers can be identified and aligned with respect to each other so as to overlap a number of optical elements that are aligned with respect to each other and that thus ensure the realization of the optical design described.

During the manufacturing process, the transparency condition of the silicon or silicon nitride in the infrared is used to enable targeting of the markers for aligning the various membranes.

FIG. 3C shows a sequence 303 of aligned optical elements 303a, 303b, 303c and implemented on silicon or silicon nitride membranes.

The thicknesses of the silicon substrates 303-1a, 303-1b can be controlled and defined so as to respect the optical design plan.

Alternatively, the optical demultiplexing device 2 of the first embodiment or the optical demultiplexing device 102 of the second embodiment are realized with:

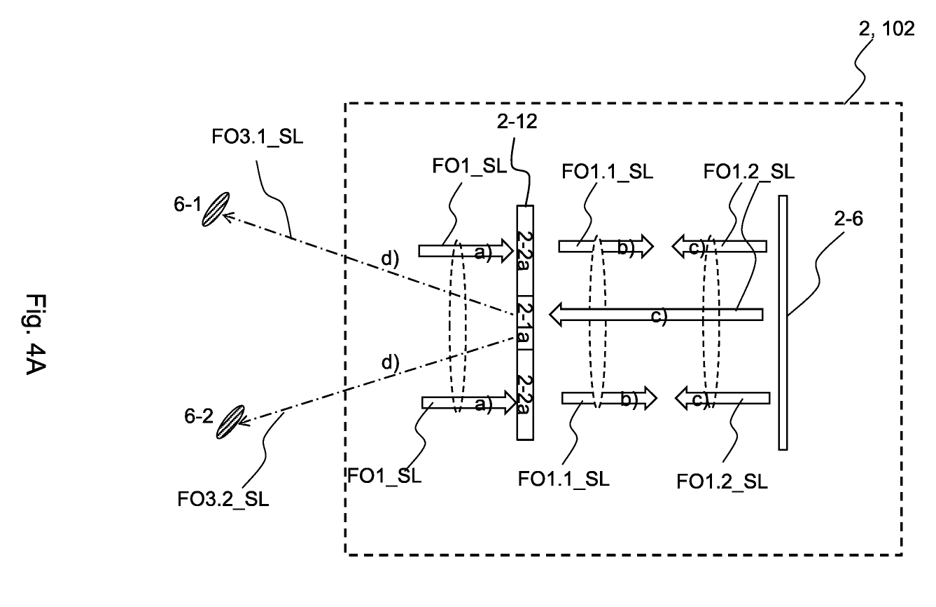

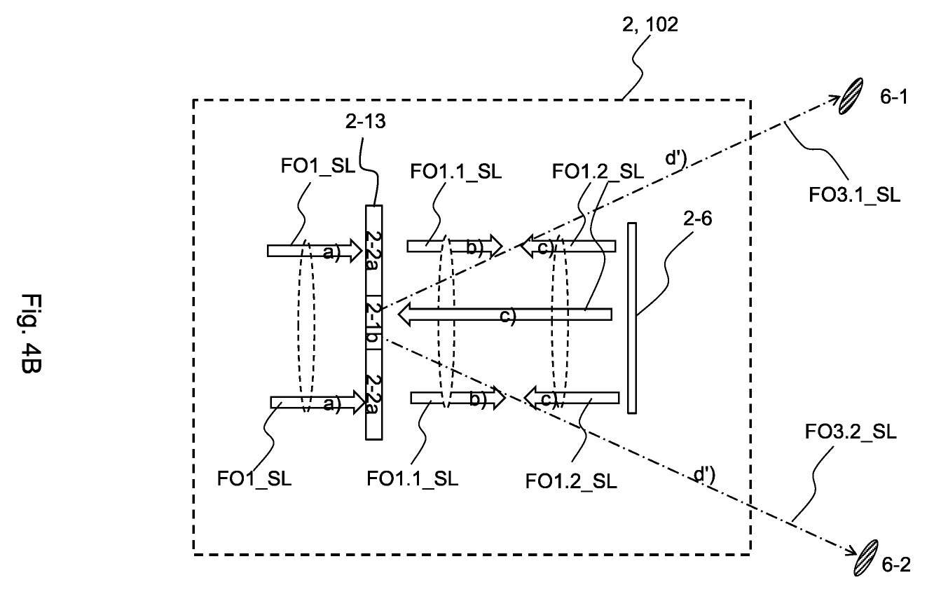

a single diffractive optical element 2-12 and with a reflecting optical element 2-6 (e.g. a mirror) as shown in FIG. 4A; or

a single diffractive optical element 2-13 and with the reflecting optical element 2-6, as shown in FIG. 4B.

This can be done using particular OAM beams called “perfect vortices”, in which the geometry of the optical vortex, in terms of the radius and width of the ring of intensity, is independent of its orbital angular momentum value l; in the solutions usually utilized, however, the dimensions of the OAM beam increase with the increase in the angular index l.

The application of optical vortices for exciting and propagating guided OAM modes in an optical fiber has revealed the need to control the geometry of the beam regardless of the OAM value being carried; furthermore, the miniaturization and integration of the lenses calls for confinement of the beams in limited and well-defined geometries.

The use of OAM beams of the “perfect vortices” type significantly reduces the useful area in which the diffractive element acts on the incident field; in the considered case, this allows to substitute the internal area of the first diffractive optical element 2-1—said area not being illuminated by the beam at the input—with the phase pattern of the second optical element 2-2, thus obtaining a single diffractive optical element 2-12 (FIG. 4A) or 2-13 (FIG. 4B).

This considerably simplifies the architecture, increasing its compactness and the degree of miniaturization and enormously simplifying the alignment procedures, because the two optical elements now prove to be coplanar and aligned structurally.

Moreover, the replacement of two complex optical elements with just one element reduces manufacturing time and thus the production costs of such lenses.

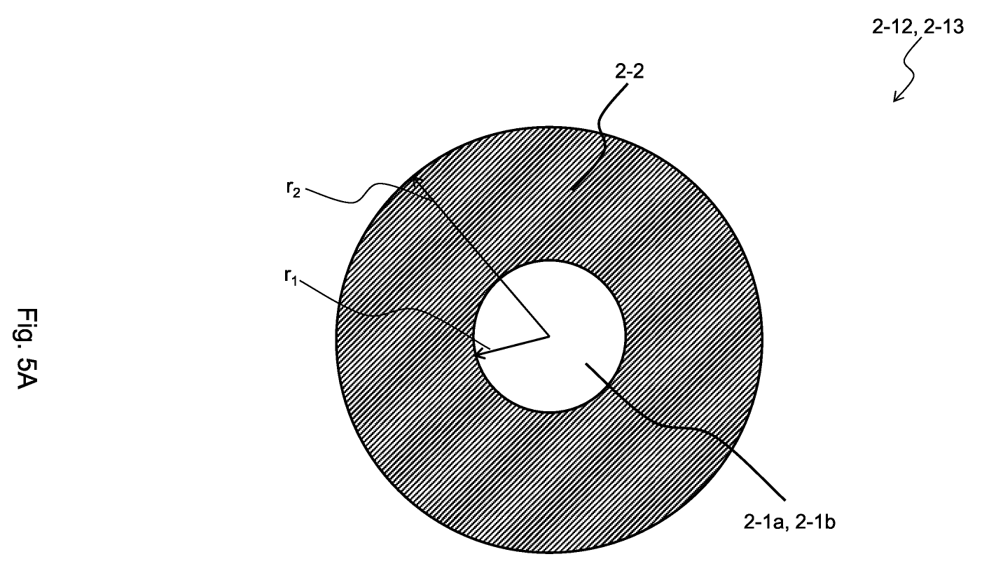

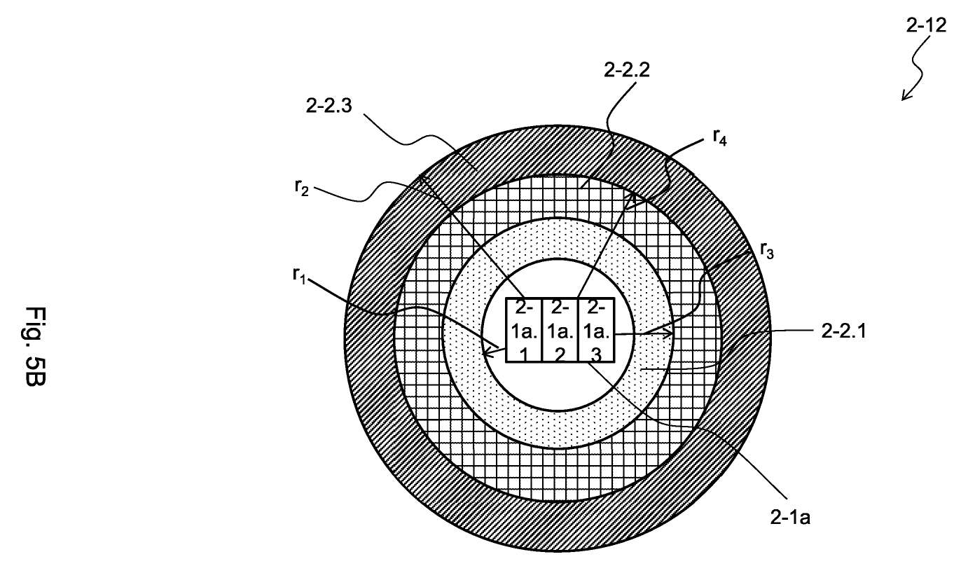

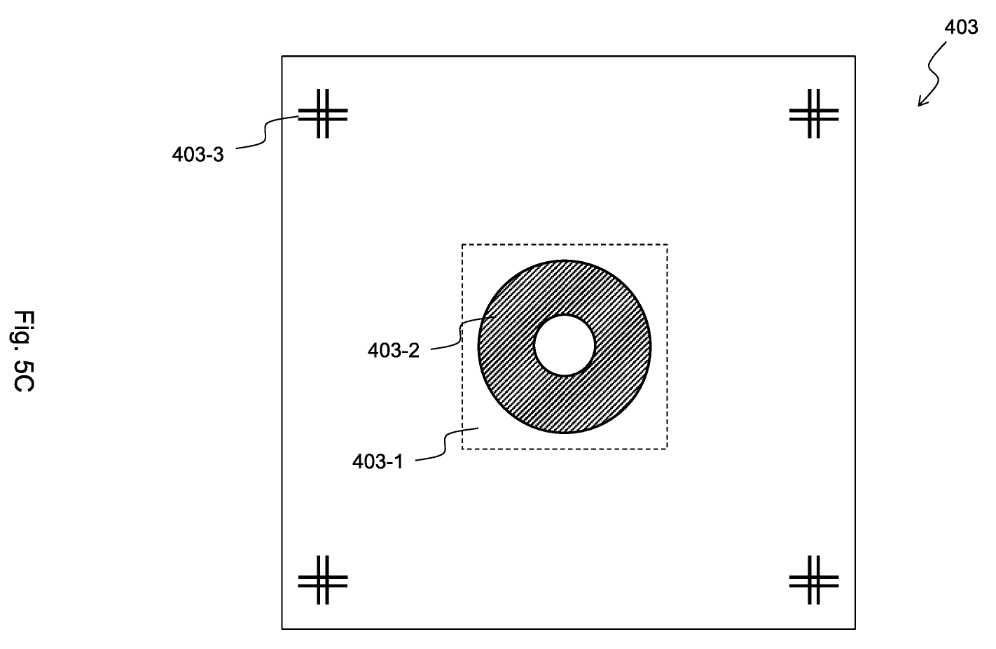

Referring in particular to FIGS. 4A-4B and 5A, each one of the diffractive optical elements 2-12 and 2-13 comprises:

a internal circular zone 2-1a of the transmitting type (FIG. 4A) or, alternatively, a internal circular zone 2-1b of the reflecting type (FIG. 4B), both defined by an inner radius r₁;

an external zone 2-2a of a transmitting type, having the shape of a circular annulus concentric with the circular internal zone 2-1a and being defined by the inner radius r₁ and by an outer radius r₂ larger than r₁.

The term “circular annulus” is understood as an area delimited by two distinct coplanar concentric circumferences.

Referring in particular to the first embodiment of FIG. 1A, the free space optical beam FO1_SL (transmitted at the output of the optical fiber 4 and suitably collimated and shaped) is incident on the external zone 2-2a of the diffractive optical element 2-12 (see letter a) in FIG. 4A), then the diffractive optical element 2-12 transmits at the output of the external zone 2-2a a free space optical beam FO1.1_SL (see letter b) in FIG. 4A).

Subsequently, the free space optical beam FO1.1_SL is incident on the reflecting optical element 2-6 and is reflected, generating a reflected free space optical beam FO1.2_SL having a propagation direction directed towards the diffractive optical element 2-12 (see letter c) in FIG. 4A).

Subsequently, the reflected free space optical beam FO1.2_SL is incident on the internal zone 2-1a of the diffractive optical element 2-12, then the diffractive optical element 2-12 transmits at the output of the internal zone 2-1a the free space optical beam FO3.2_SL having the first direction in the space and the free space optical beam FO3.2_SL having the second direction in the space (see letter d) in FIG. 4A), as explained previously.

The diffractive optical element 2-13 shown in FIG. 4B has an operation similar to the one of diffractive optical element 2-12, with the difference that the internal zone 2-1b is of the reflecting type.

Therefore, the reflected free space optical beam FO1.2_SL is incident on the internal zone 2-1b of the diffractive optical element 2-13, then the diffractive optical element 2-12 reflects, from the internal zone 2-1b, the free space optical beam FO3.1_SL having the first direction in the space and the free space optical beam FO3.2_SL having the second direction in space (see letter d′) in FIG. 4B).

More specifically, the following is the phase function of the diffractive optical elements 2-12 and 2-13:

ϕ(x,y)=ϕ₁Θ(r−r*)+ϕ₂Θ(r*−r)

wherein:

$${φ}_{1} ( x , y ) = \frac{2 π a}{λ {f}_{1}} [ y arctan ( \frac{y}{x} ) - x ln ( \frac{\sqrt{{x}^{2} + {y}^{2}}}{b} ) + x + \frac{{x}^{2} + {y}^{2}}{2 a} ]$$

$${φ}_{2} ( x , y ) = [ - \frac{2 π ab}{λ {f}_{1}} exp ( - \frac{x}{a} ) cos ( \frac{y}{a} ) + \frac{2 π}{λ} \frac{{x}^{2} + {y}^{2}}{2 {f}_{2}} ]$$

wherein:

Θ is the Heaviside function, thus defined;
Θ(x)=0 for x<0;
Θ(x)=1 for x>0;

r* is the separation radius between the external zone 2-2a and the internal zone 2-1a (that is, r*=r₁);

f₁ is the focal distance of the diffractive optical elements 2-12 and 2-13;

f₂ is the focal distance of the lens 2-4 interposed between the optical demultiplexing device 2 and the diffractive optical element 6 of the first embodiment (or interposed between the optical demultiplexing device 102 and the diffractive optical element 106 of the second embodiment).

In one embodiment, the diffractive optical element 2-12 (or 2-13) is implemented with a respective holographic mask having the structure of a surface that has continuous phase values comprised between 0 and 2π.

Alternatively, the diffractive optical element 2-12 (or 2-13) is implemented with a respective holographic mask having the structure of a multi-level surface, that is composed of a plurality of pixels (that is, a matrix of pixels), each pixel having discrete phase and/or amplitude values.

Alternatively, the diffractive optical element 2-12 (or 2-13) is implemented with diffraction by means of pixels formed by digital gratings with a period smaller than the wavelength and an orientation proportional to the phase: in this manner, the phase term is not due to the optical path of the wave inside the material, but it is due to local manipulation of the state of polarization of the incident wave and it is linked to the space-variant Pancharatnam-Berry phase.

The amplitude of the grating is such to determine a phase shift of 180° between a polarized wave parallel to the grating and a polarized wave perpendicular to it, and it will depend on the type of material and duty cycle of the grating.

In this way the diffractive optical element 2-12 (or 2-13) is affected by the circular state of polarization of the incident light.

In particular, in the case of a dextrorotatory circular state of polarization σ+, the phase imparted by the diffractive optical element 2-12 (or 2-13) to the optical beam incident on it shall be the following:

ϕ⁺(x,y)=ϕ₁Θ(r−r*)+ϕ₂Θ(r*−r)

wherein:

$${φ}_{1} ( x , y ) = \frac{2 π a}{λ {f}_{1}} [ y arctan ( \frac{y}{x} ) - x ln ( \frac{\sqrt{{x}^{2} + {y}^{2}}}{b} ) + x ] Θ ( r - {r}^{*} )$$

$${φ}_{2} ( x , y ) = [ - \frac{2 π ab}{λ {f}_{1}} exp ( - \frac{x}{a} sgn x ) cos ( \frac{y}{a} ) + α x + β y ] Θ ( {r}^{*} - r )$$

wherein sgn(x)=1 for x>0, sgn(x)==−1 for x≤0, and wherein the parameters (α, β) control the position of the array of the points of light generated on the photo-detector 5.

In the case of a levorotatory circular state of polarization σ−, the phase imparted by the diffractive optical element 2-12 (or 2-13) to the optical beam incident on it shall be the following:

ϕ⁻(x,y)=−ϕ₁Θ(r−r*)−ϕ₂Θ(r*−r)

If a lens 2-4 having a focal distance f₂ is positioned after the diffractive optical element 2-12 (or 2-13), the following is the result on the detecting surface of the photo-detector 5 positioned at the far-field distance.

Once the wavelength λ of the optical beam incident on the diffractive optical element 2-12 (or 2-13) is fixed, the position at the far-field distance of the point of light generated on the photo-detector 5 depends on the value of the angular index l according to the following coordinates (y^{±}ₗ, X^{±}ₗ):

$${y}_{l}^{\pm } = \pm \frac{λ {f}_{2}}{2 π} ( \frac{𝓁}{a} + β )$$

$${x}_{l}^{\pm } = \pm \frac{λ {f}_{2}}{2 π} α$$

wherein the “+” sign refers to the dextrorotatory circular state of polarization and the “−” sign refers to the levorotatory circular state of polarization.

In particular, in this embodiment the reflecting optical element 2-6 is a concave mirror with a radius of curvature equal to 2*f₁.

According to a third embodiment of the disclosure, the optical communication system (in particular, the optical device 10) has not only the function of performing the demultiplexing of guided OAM modes with a different orbital angular momentum as illustrated in the first embodiment (or, alternatively, the demultiplexing of guided OAM modes with a different orbital angular momentum and a different state of polarization, as illustrated in the second embodiment), but it also has the function of performing wavelength division demultiplexing (WDM).

Referring once again to the single diffractive optical element 2-12 implemented as previously illustrated in FIG. 5A, this allows to perform both the demultiplexing of guided OAM modes with a different orbital angular momentum (or, alternatively, the demultiplexing of guided OAM modes with a different orbital angular momentum and a different state of polarization) and the demultiplexing of different wavelengths of DWDM-type (i.e., Dense WDM, in which the channels are centred on the value of the wavelength equal to 1550 nm and they are spaced by 0.7 nm or less, which corresponds to a band of 100 Ghz).

In one embodiment, the same diffractive optical element 2-12 is used to perform the demultiplexing of different wavelengths spaced by less than 5 nm, as in the case of LAN-WDM technology, which uses groups of 4 wavelengths separated by about 5 nm starting from the upper limit of 1310 nm.

In one embodiment, the configurations of FIGS. 5A and 5B can be integrated in lenses constituted by silicon membranes, realizing lenses with continuous phase values or alternatively with matrices of pixels of gratings with a period smaller than the wavelength (Pancharatnam-Berry optical elements).

FIG. 5C shows the optical element 403 in which the configuration 2-12 is realized on the silicon membrane 403-1.

The dimensions are not scaled and different configurations can be integrated.

The function of the reflecting surface can the implemented by means of deposition of reflecting metals deposited in the form of a thin film and the elements are shaped according to the embodiments shown in FIGS. 4A and 4B.

Chrome or nickel films can have a surface with roughness such to reflect the light of the beam, preserving the spatial structure of the OAM modes.

The circular annulus can reflect light on both the upper and lower surface of the membrane. Specific markers 403-3 are placed on the element 403 for the purpose of facilitating alignment with the other components of the device.

With reference to FIG. 5B, it shows more in details a possible embodiment of the diffractive optical element 2-12 of FIG. 4A, which allows to perform both the demultiplexing of guided OAM modes with different orbital angular momentum (or, alternatively, the demultiplexing of guided OAM modes with different orbital angular momentum and different state of polarization) and the demultiplexing of different wavelengths of CWDM-type (i.e., coarse WDM, which are spaced by at least 20 nm starting from the upper limit of 1610 nm).

In this case, the optical demultiplexing device 10 further comprises a diffractive/dispersive optical element interposed between the output of the optical fiber 4 and the input of the optical demultiplexing device 2 (or, if the lens 3 is present, interposed between the output of the lens 3 and the input of the optical demultiplexing device 2).

The diffractive/dispersive optical element has the function of performing chromatic dispersion of the multiplexed incident optical beam, imparting different radii of curvature to the wavefronts of the output optical beams (i.e., wavefronts having a different divergence), wherein the values of the radii of curvature (i.e., of the divergence) associated with the different channels at the output of said diffractive/dispersive optical element depend on the value of the wavelength λ.

The diffractive/dispersive optical element can be implemented with a Fresnel lens or with an axicon, as explained with reference to the diffractive optical element 1-1 disclosed in the Italian patent application no. 102015000041388 filed on Aug. 4, 2015 in the name of the same Applicant.

In the case wherein the diffractive/dispersive optical element is implemented with a Fresnel lens, the latter is composed of a plurality of concentric circular annuli, wherein said plurality of circular annuli have different radial thicknesses decreasing as a function of the increasing value of the radius: this allows to perform chromatic dispersion in a range of values of the wavelength λ in which the material (of which the diffractive/dispersive optical element 1-1 is made) is transparent with respect to the incident optical beams.

In the case wherein the diffractive/dispersive optical element is implemented with an axicon, the latter is a lens made of a flat surface and a conical surface, the latter facing towards the optical demultiplexing device 2.

In this case, the axicon operates as a prism having circular symmetry, performing the dispersion of the different wavelengths λ₁, λ₂, . . . and maintaining at the same time the circular symmetry of the distribution of the luminous intensity of the multiplexed incident optical beam: in this way its content of the angular indices l₁, l₂, l₃, . . . of the guided OAM modes carried by the multiplexed incident optical beam is preserved.

Referring in particular to the diffractive optical element 2-12, the external zone 2-2a comprises a plurality of zones, each one being associated with a respective wavelength; analogously, the internal zone 2-1a of the diffractive optical element 2-12 comprises a plurality of zones, each one being associated with a respective wavelength.

In FIG. 5B, for the sake of simplicity, three wavelengths λ₁, λ₂, λ₃ of the CWDM type are considered.

In this case, the external zone 2-2a is subdivided into three concentric circular annuli 2-2.1, 2-2.2 and 2-2.3, one for each wavelength λ1, λ2, λ3, wherein:

the internal circular annulus 2-2.1 is comprised between the radii r₁ and r₃ and it is associated with the wavelength λ1;

the central circular annulus 2-2.2 is comprised between the radii r₃ and r₄ and it is associated with the wavelength λ2;

the external circular annulus 2-2.3 is comprised between the radii r₄ and r₂ and it is associated with the wavelength λ3.

Analogously, the internal zone 2-1a also comprises three zones 2-1a.1, 2-1a.2 and 2-1a.3, one for each wavelength λ1, λ2, λ3, wherein:

zone 2-1a.1 is associated with the wavelength λ1;

zone 2-1a.2 is associated with the wavelength λ2;

zone 2-1a.3 is associated with the wavelength λ3.

The preceding considerations concerning the embodiment of the diffractive optical element 2-12 in FIG. 5B are applicable in a similar manner to the diffractive optical element 2-13 in FIG. 4B, that is the diffractive optical element 2-13 also allows to perform both the demultiplexing of guided OAM modes with a different orbital angular momentum (or, alternatively, the demultiplexing of guided OAM modes with a different orbital angular momentum and a different state of polarization) and the demultiplexing of different wavelengths.

In one embodiment, the configuration shown in FIG. 5B can be integrated in lenses formed by silicon membranes, realizing lenses with continuous phase values or with matrices of pixels of Pancharatnam-Berry.

In one embodiment, the single pixel is implemented in the form of a digital grating with a period smaller than the wavelength and an orientation proportional to the phase: in this way the phase term is not due to the optical path of the wave inside the material, but it is due to local manipulation of the state of polarization of the incident wave and it is linked to the spatial phase of Pancharatnam-Berry.

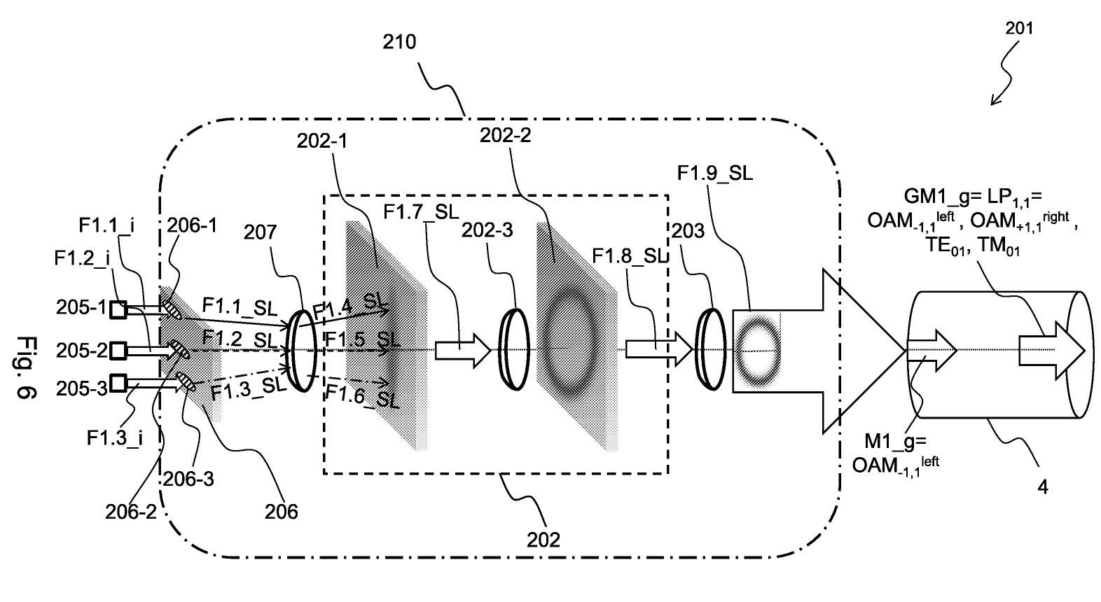

With reference to FIG. 6, it shows scheamtically a mode division multiplexing optical communication system 201 according to the disclosure.

More specifically, the optical communication system 201 has the function of performing multiplexing of guided OAM modes with a different orbital angular momentum.

The multiplexing optical communication system 201 is similar to the demultiplexing optical communication system 1 because it comprises a reverse path for the optical beams based on the time invariance of Maxwell's equations; the minimal differences are identifiable in the different architecture for generating the optical signal with respect to that for receiving the optical signal.

In other words, the multiplexing system for multiplexing signals and insertion into a fiber is described by analogy to the demultiplexing system, considering reciprocity by virtue of the symmetry linked to the time reversal invariance between the demultiplexing and multiplexing processes.

The mode division multiplexing optical communication system 201 comprises an optical multiplexing device 210 for multiplexing guided OAM modes and the multimode optical fiber 4 illustrated in the preceding embodiments.

The optical multiplexing device 210 has the function of performing the multiplexing of guided OAM modes with a different orbital angular momentum (that is, with different values l₁, l₂, l₃ of the angular index l).

The optical multiplexing device 210 comprises an optical element 206 of the diffractive type, an optical multiplexing device 202 and, in particular, a lens 203 interposed between the optical multiplexing device 202 and the optical fiber 4.

The diffractive optical element 206 has a complementary function with respect to that of the diffractive optical elements 6, 106 of the first and second embodiments.

More specifically, the diffractive optical element 206 is configured to receive at the input a first plurality of free space optical beams F1.1_SL, F1.2_SL, F1.3_SL generated from a respective plurality of coherent light sources 205-1, 205-2, 205-3 (e.g. of a laser type) and it is configured to generate therefrom at the output a respective second plurality of free space optical beams F1.1_SL, F1.2_SL, F1.3_SL oriented towards different directions in the space depending on the plurality of different values of the angular index l₁, l₂, l₃ of the guided OAM modes that will be subsequently injected into the optical fiber 4.

Note that in FIG. 6, for the sake of simplicity, three sources of coherent light are shown, but more in general two or more coherent light sources may be present and thus the diffractive optical element 206 is configured to generate two or more free space optical beams oriented towards two or more respective directions in space.

The optical multiplexing device 202 has a complementary function with respect to that of the optical demultiplexing device 2, 102 of the first and second embodiments of FIGS. 1A-1B and 2.

More specifically, the optical multiplexing device 202 is configured to receive at the input the second plurality of free space optical beams oriented towards different directions in the space and it is configured to generate therefrom at the output a multiplexed free space circular optical vortex F1.8_SL carrying an overlap of the second plurality of free space input optical beams.

The optical fiber 4 is configured to receive at the input the multiplexed free space circular optical vortex F1.8_SL carrying an overlap of the second plurality of free space optical beams and it is configured to excite therefrom a respective plurality of optical signals carried by a respective plurality of guided OAM modes having respective values of the angular index l and belonging to different groups of degenerate or quasi-degenerate guided modes, in a manner similar to that explained above for the optical fiber 4 of the first and second embodiments of FIGS. 1A-1B and 2.

During the propagation of the plurality of optical signals from the input to an output of the optical fiber 4, at least part of the energy of each optical signal out of the plurality of optical signals is distributed over another guided mode belonging to the respective group of guided modes, in a manner similar to that explained above for the modes groups GM1_g and GM2_g of the first embodiment of FIGS. 1A-1B and for the modes group GM2_g of the second embodiment of FIG. 2.

The coherent light source 205-1 generates a first monochromatic optical beam F1.1_i, suitably circularly polarized, which illuminates the diffractive optical element 206 on a first zone 206-1.

The diffractive optical element 206 is configured to receive at the input, on the first zone 206-1, the first optical beam F1.1_i and it is configured to suitably shape at the output the first optical beam F1.1_SL so as to give it a first specific propagation direction in the space depending on the first illumination zone 206-1 and it is associated with a first determined value l₁ of the orbital angular momentum l.

In one embodiment, the optical multiplexing device 210 further comprises a lens 207 interposed between the diffractive optical element 206 and the optical multiplexing device 202.

The lens 207 is a converging type of lens and it has the function of collimating the free space optical beam F1.1_SL.

The diffractive optical element 206 thus generates at the output the free space optical beam F1.1_SL, which illuminates the optical multiplexing device 202.

Upon changing of the direction of the incidence of the free space beam F1.1_SL, the optical multiplexing device 202 generates at the output a free space circular optical vortex F1.8_SL having a specific value of the orbital angular momentum, which is associated with a specific value of the angular index l of the guided OAM mode that will be transmitted in the optical fiber 4.

The lens 203 has the function of collimating and suitably shaping the free space circular optical vortex F1.8_SL so as to allow the input into the optical fiber 4, generating a collimated free space circular optical vortex F1.9_SL.

The optical fiber 4 receives at its input the collimated free space circular optical vortex F1.8_SL, which excites a specific guided OAM mode, such as the guided OAM mode M1_g of the first embodiment or the guided OAM mode M2_g of the second embodiment.

The preceding considerations concerning the light source 205-1 are applicable in a similar manner to the coherent light sources 205-2 and 202-3, that is:

the diffractive optical element 206 is configured to receive at the input, on a second zone 206-2, a second optical beam F1.2_SL and it is configured to suitably shape at the output the second optical beam F1.2_SL so as to give it a second specific propagation direction in the space depending on the second illumination zone 206-2 and it is associated with a second determined value l₂ of the orbital angular momentum l;

the diffractive optical element 206 is configured to receive at the input, on a third zone 206-3, a third optical beam F1.3_SL and it is configured to suitably shape at the output the third optical beam F1.3_SL so as to give it a third specific propagation direction in the space depending on the third illumination zone 206-3 and it is associated with a third determined value l₃ of the orbital angular momentum l.

For example, a coherent light source 205-1 generates the optical beam F1.1_i, suitably collimated and polarized with a levorotatory circular polarization state, then the optical beam F1.1_i illuminates the first zone 206-1 of the diffractive optical element 206 associated with the angular index having a value l=−1 and the free space optical beam F1.4_SL is generated, said beam F1.4_SL being incident on the optical multiplexing device 202 with a specific angle of incidence.

The optical multiplexing device 202 generates at the output the circular optical vortex F1.8_SL carrying a content of an orbital angular momentum l=−1, then it is suitably collimated and shaped, illuminating the head of the optical fiber 4 and lastly, it excites the guided OAM mode of the OAM_{-1,1}_{^{left}} type.

In one embodiment, the optical multiplexing device 202 comprises two diffractive optical elements 202-1, 202-2 which implement an geometric optical transformation of the reverse log-pol type, that is by implementing the conversion of a linear intensity distribution into an intensity distribution with azimuthal symmetry typical of the OAM modes.

The phase function of the first diffractive optical element 202-1 is similar to that of the second diffractive optical element 2-2 of the first embodiment of FIG. 1A-1B or to that of the second diffractive optical element 102-2 of the second embodiment in FIG. 2.

The phase function of the second diffractive optical element 202-2 is similar to that of the first diffractive optical element 2-1 of the first embodiment in FIG. 1A-1B or to that of the first diffractive optical element 102-1 of the second embodiment in FIG. 2.

In one embodiment, the optical multiplexing device 202 further comprises a lens 202-3 interposed between the output of the first diffractive optical element 202-1 and the input of the second diffractive optical element 202-2.

The lens 203-3 is a converging type of lens and it has the function of collimating the free space optical beam F1.2_SL at the output of the first diffractive optical element 202-1 and incident on the second diffractive element 202-2.

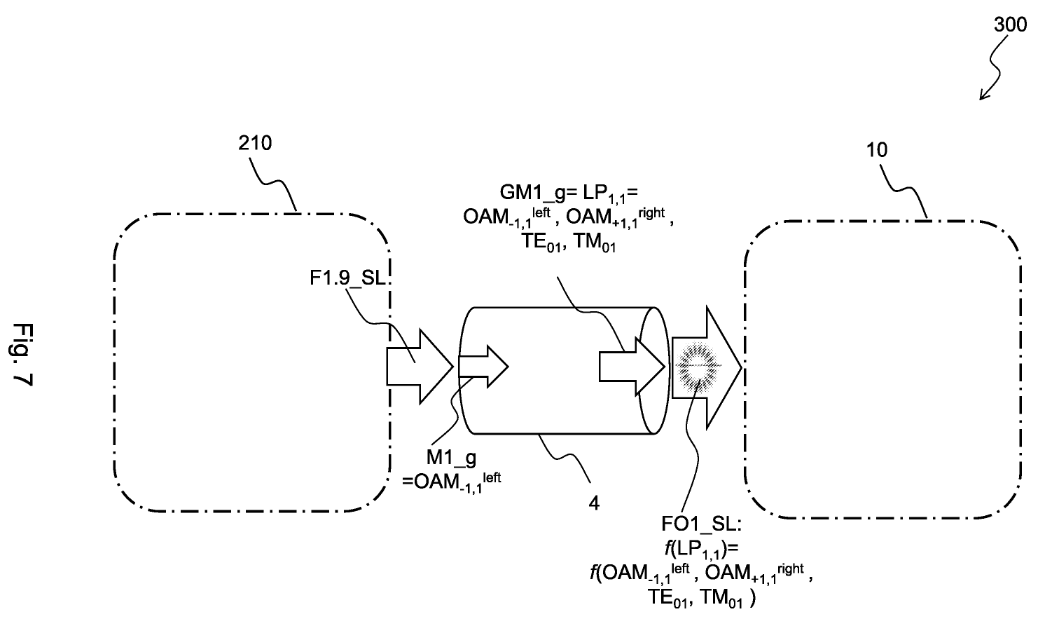

With reference to FIG. 7, it schematically shows an optical transceiver system 300 for performing mode division multiplexing and demultiplexing according to the disclosure.

The optical transceiver system 300 has both the function of performing multiplexing of guided OAM modes with different orbital angular momentum and the function of performing demultiplexing of guided OAM modes with different orbital angular momentum.

More specifically, the optical transceiver system 300 comprises the optical multiplexing device 210, the multimode optical fiber 4 and the optical demultiplexing device 10 according to the first, second or third embodiment and variants thereof, as illustrated above.

One embodiment of the present disclosure relates to a method for manufacturing optical elements with micro- and nano-fabrication techniques.

In particular, said method can be used to manufacture optical elements in the form of pixels of digital gratings and thus it can be used to manufacture:

the optical demultiplexing device 2 of the first embodiment, both in the case wherein it is implemented with two diffractive optical elements 2-1 and 2-2, and in the case wherein it is implemented with a single diffractive optical element 2-12 or 2-13;

the optical demultiplexing device 102 of the second embodiment, in the case wherein it is implemented with two diffractive optical elements 102-1 and 102-2, and in the case wherein it is implemented with a single diffractive optical element 2-12 or 2-13;

the diffractive optical element 6 of the first embodiment;

the diffractive optical element 106 of the second embodiment;

the optical multiplexing device 202, both in the case wherein it is implemented with two diffractive optical elements 202-1 and 202-2, and in the case wherein it is implemented with a single diffractive optical element.

One embodiment of the present disclosure relates to a further mode division demultiplexing optical communication system.

The further optical communication system comprises a multimode optical fiber, a mode demultiplexing optical device and a diffractive optical element.

The multimode optical fiber is configured to:

receive at the input a first optical signal carried by a first guided mode, wherein the first guided mode belongs to a first group of guided modes comprising a first plurality of degenerate or quasi-degenerate guided modes;

distribute, during the propagation of the first optical signal from the input to an output of the optical fiber, at least a part of the energy of the first optical signal of the first guided mode over the first plurality of guided modes of the first group of modes;

generate at the output the first optical signal carried by the first group of guided modes;

The mode demultiplexing optical device is configured to:

receive at the input a free space optical beam generated from the first output optical signal of the first group of modes;

generate at the output, as a function of said input optical beam, a first plurality of free space optical beams having a respective first plurality of different directions in the space.

The diffractive optical element is configured to:

receive at the input, on a first plurality of zones, the first plurality of free space optical beams and generate therefrom at the output a respective first plurality of collimated optical beams at the far-field distance;

converge the first plurality of collimated optical beams into a same first point in the space.

In one embodiment, the optical fiber of the further optical communication system is further configured to:

further receive at the input a second optical signal carried by a second guided mode, wherein the second guided mode belongs to a second group of guided modes comprising a second plurality of degenerate or quasi-degenerate guided modes;

distribute, during the propagation of the second optical signal from the input to the output of the optical fiber, at least a part of the energy of the second optical signal of the second guided mode over the second plurality of guided modes of the second group of mode;

generate at the output the second optical signal carried by the second group of guided modes.

The mode demultiplexing optical device of the further optical communication system is further configured to:

receive at the input said free space optical beam generated from the first and the second output optical signal of the first and the second group of modes, respectively;

further generate at the output, as a function of said input optical beam, a second plurality of free space optical beams having a respective second plurality of different directions in space.

The diffractive optical element of the further optical communication system is configured to:

further receive at the input, on a second plurality of zones, the second plurality of free space optical beams and generate therefrom at the output a respective second plurality of collimated optical beams at the far-field distance;

converge the second plurality of collimated optical beams into a same second point in space.

In one embodiment, the first and the second guided modes are guided OAM modes and the first and second group of guided modes comprise at least one respective pair of guided OAM modes having the same absolute value and opposite sign of the respective angular index.

1. A mode division demultiplexing optical communication system, the system comprising:
a multimode optical fiber configured to:
receive at the input a first optical signal carried by a first guided mode having an orbital angular momentum identified by a first angular index, wherein the first guided mode belongs to a first group of degenerate or quasi-degenerate guided modes, said first group comprising a first pair of guided modes having the same absolute value and opposite sign of the first angular index;
distribute, during the propagation of the first optical signal from the input to an output of the optical fiber, at least a part of the energy of the first optical signal of the first guided mode over the other guided mode belonging to the first pair and having the same absolute value and opposite sign of the first angular index;
generate at the output the first optical signal carried by the first group of guided modes;
an optical device for demultiplexing modes with different orbital angular momentum, the optical demultiplexing device being configured to:
receive at the input a free space optical beam generated from the first output optical signal of the first modes group;
generate at the output, as a function of said input optical beam, a first pair of free space optical beams having a first and a second direction in the space depending on the absolute value and sign of the first angular index;
a diffractive optical element configured to:
receive at the input, on a first pair of zones, the first pair of free space optical beams and generate therefrom at the output a first pair of collimated optical beams at the far-field distance;
converge the first pair of collimated optical beams into a same first point in the space.

2. The optical communication system according to claim 1, wherein the optical fiber is further configured to:
further receive at the input a second optical signal carried by a second guided mode having an orbital angular momentum identified by a second angular index, wherein the second guided mode belongs to a second group of degenerate or quasi-degenerate guided modes, said second group comprising a second pair of guided modes having the same absolute value and opposite sign of the second angular index;
distribute, during the propagation of the second optical signal from the input to the output of the optical fiber, at least a part of the energy of the second optical signal of the second guided mode over the other guided mode belonging to the second pair and having the same absolute value and opposite sign of the second angular index;
generate at the output the second optical signal carried by the second group of guided modes;
wherein the optical demultiplexing device is further configured to:
receive at the input said free space optical beam generated from the first and the second output optical signal of the first and the second modes group, respectively;
further generate at the output, as a function of said input optical beam, a second pair of free space optical beams having a third and a fourth direction in the space depending on the absolute value and sign of the second angular index;
and wherein the diffractive optical element is further configured to:
further receive at the input, on a second pair of zones, the second pair of free space optical beams and generate therefrom at the output a second pair of collimated optical beams at the far-field distance;
converge the second pair of collimated optical beams into a same second point in the space.

3. The optical communication system according to claim 2, wherein the second modes group comprises a further second pair of guided modes having the same absolute value and opposite sign of the second angular index and wherein the polarization state of the further second pair of guided modes is different from the polarization state of the second pair of guided modes, wherein the optical fiber is further configured to:
further distribute, during propagation of the second optical signal from the input to the output of the optical fiber, at least a part of the energy of said second optical signal over the other guided mode belonging to the further second pair;
generate at the output the second optical signal carried by the second group of guided modes;
and wherein the optical demultiplexing device is further configured to:
receive at the input said free space optical beam generated from the first and from the second output optical signal of the first and the second group of modes, respectively;
generate at the output, as a function of said input optical beam, the second pair of free space optical beams having the third and the fourth direction in the space depending on the absolute value and sign of the second angular index;
and wherein the diffractive optical element is further configured to:
receive at the input, on the first pair of zones, the first pair of free space optical beams and generate therefrom at the output the first pair of collimated optical beams at the far-field distance;
receive at the input, on the second pair of zones, the second pair of free space optical beams and generate therefrom at the output the second pair of collimated optical beams at the far-field distance;
converge the first pair of collimated optical beams into the first point in the space;
converge the second pair of collimated optical beams into the second point in the space.

4. The optical communication system according to claim 1, wherein the optical fiber is further configured to receive at the input a plurality of optical signals carried by a respective plurality of guided modes having different angular indices, wherein the guided modes of the plurality of guided modes belong to different groups of degenerate or quasi-degenerate guided modes,
and wherein the diffractive optical element is further configured to generate at the output a plurality of collimated free space optical beams associated with the plurality of optical signals and converging into a respective plurality of a number of different points equal to the plurality of optical signals.

5. The optical communication system according to claim 1, wherein the diffractive optical element is implemented with a diffraction grating with a spatially variable period,
wherein the diffraction grating is configured to:
receive at the input the first pair of free space optical beams and/or the second pair of free space optical beams on the first and second pair of zones, respectively;
transmit or reflect at the output the first and/or second pair of collimated optical beams converging into the first and second point in the space, respectively.

6. The optical communication system according to claim 5, wherein the diffraction grating includes an anisotropic curvature term, which differs over two perpendicular directions, configured to:
focus the first and/or second pair of collimated optical beams into the first and the second point in the space, respectively;
shape the profile of the respective points of light generated by the first and/or second pair of focused optical beams.

7. The optical communication system according to claim 3, wherein
the optical demultiplexing device is further configured to perform a polarization division demultiplexing;
the second modes group comprises the second pair of guided modes having the same absolute value and opposite sign of the second angular index and having same polarization state;
the second modes group comprises said further second pair of guided modes having the same absolute value and opposite sign of the second angular index and having the same polarization state, wherein the polarization state of the second pair of guided modes is different from the polarization state of the further second pair of guided modes;
wherein the optical demultiplexing device is configured to:
receive at the input said free space optical beam generated from the second output optical signal of the second modes group;
generate at the output, as a function of said input optical beam, the second pair of free space optical beams having the first and the second direction in the space depending on the absolute value and sign of the second angular index and depending on the polarization state;
generate at the output, as a function of said input optical beam, a further second pair of free space optical beams having the third and the fourth direction in the space depending on the absolute value and sign of the second angular index and depending on the polarization state;
and wherein the diffractive optical element is further configured to:
receive at the input, on the second pair of zones, the second pair of free space optical beams and generate therefrom at the output a second pair of collimated optical beams at the far-field distance;
receive at the input, on the second pair of zones, the further second pair of free space optical beams and generate therefrom at the output a further second pair of collimated optical beams at the far-field distance;
converge the second pair of collimated optical beams into the same second point in the space;
converge the further second pair of collimated optical beams into the same third point in the space.

8. The optical communication system according to claim 1, wherein the optical demultiplexing device comprises a first and a second diffractive optical element configured to implement a geometric optical transformation of the log-pol type, wherein:
the first diffractive optical element is configured to implement a geometric conformal mapping of the free space optical beams at the output of the optical fiber from an intensity distribution with azimuthal symmetry to a linear intensity distribution;
the second optical element is configured to implement a phase correction.

9. The optical communication system according to claim 7, wherein the first and the second diffractive optical element are implemented with Pancharatnam-Berry optical elements configured to control phase delays by means of the local manipulation of the polarization state of the incident optical beam.

10. The optical communication system according to claim 1, wherein the optical demultiplexing device comprises a single diffractive optical element configured to implement a geometric optical transformation of the log-pol type,
wherein the single diffractive optical element comprises:
an external zone configured to map the intensity distribution with azimuthal symmetry of the free space optical beams at the output of the optical fiber into a linear intensity distribution;
an internal zone configured to perform a phase correction;
wherein the optical demultiplexing device further comprises a reflecting optical element, and wherein:
the external zone of the single diffractive optical element is configured to receive the optical beam at the output of the optical fiber and to generate therefrom a transmitted optical beam;
the reflecting optical element is configured to receive the transmitted optical beam and reflect it as a reflected optical beam towards the single diffractive optical element;
the internal zone of the single diffractive optical element is configured to receive the first reflected optical beam and, alternatively, to transmit it as a transmitted optical beam or to reflect it as a further transmitted optical beam towards the diffractive optical element.

11. The optical communication system according to claim 10, wherein the external zone and the internal zone of the first diffractive optical element are implemented with Pancharatnam-Berry optical elements configured to control the phase delays by means of the local manipulation of the polarization state of the incident optical beam.

12. The optical communication system according to claim 8, wherein the first and second diffractive optical element or the single diffractive optical element are implemented by means of pixels of binary gratings with a period smaller than the wavelength.

13. The optical communication system according to claim 10, wherein:
the optical demultiplexing device is further configured to perform a wavelength division demultiplexing of a plurality of wavelengths;
the optical communication system further comprises a diffractive/dispersive optical element interposed between the output of the optical fiber and the input of the optical demultiplexing device and configured to perform chromatic dispersion of the optical beam at the output of the optical fiber.
the external zone of the single diffractive optical element comprises a plurality of concentric annuli, one for each wavelength;
the internal zone of the single diffractive optical element comprises a plurality of zones, one for each wavelength.

14. The optical communication system according to claim 1, further comprising a photo-detector to perform opto-electrical conversion, wherein the first and/or second point in the space are positioned on the detection surface of the photo-detector.

15. A mode division multiplexing optical communication system, the system comprising a diffractive optical element, a mode multiplexing optical device with a different orbital angular momentum and a multimode optical fiber, wherein:
the diffractive optical element is configured to:
receive at the input, on a respective plurality of different zones, a first plurality of free space optical beams generated from a respective first plurality of coherent light sources;
generate at the output, as a function of the first plurality of free space input optical beams, a respective second plurality of free space optical beams oriented towards different directions of the space depending on a plurality of different values of the angular index of guided modes of the optical fiber;
the optical multiplexer device is configured to:
receive at the input the second plurality of free space optical beams oriented towards different directions of the space;
generate at the output, as a function of the second plurality of free space input optical beams, a multiplexed free space circular optical vortex carrying an overlap of the second plurality of free space input optical beams;
the multimode optical fiber is configured to:
receive at the input the multiplexed free space circular optical vortex and excite therefrom a plurality of optical signals carried by a respective plurality of guided modes having respective values of the angular index and belonging to different groups of degenerate or quasi-degenerate guided modes;
distribute, during the propagation of the plurality of optical signals from the input to an output of the optical fiber, at least part of the energy of each optical signal out of the plurality of optical signals over another guided mode belonging to the respective group of guided modes.

16. The optical communication system according to claim 1, wherein the diffractive optical elements are implemented by means of microlithographic techniques on silicon or silicon nitride membranes that are overlapped and aligned.

17. The optical transceiver system comprising a mode division multiplexing optical communication system according to claim 15 and a mode division demultiplexing optical communication system according to claim 1.
